(19) United States
(12) Patent Application Publication
(10) Pub. No.: US 2008/0143681 A1
(43) Pub. Date: Jun. 19, 2008

(54) Circular slider with center button

(76) Inventor: Jiang XiaoPing, Shanghai (CN)

Correspondence Address: CYPRESS/BLAKELY, BLAKELY SOKOLOFF TAYLOR & ZAFMAN, 1279 OAKMEAD PARKWAY, SUNNYVALE, CA, 94085-4040, US

(21) Appl. No.: 11/641,998

(22) Filed: Dec. 18, 2006

(51) Int. Cl. G06F 3/041

(52) U.S. Cl. 345/173

(57) ABSTRACT

An apparatus and method for detecting the presence of a conductive object on a sensing device. The sensing device may include a plurality of non-linearly disposed sensor elements disposed in an outer sensing area of the sensing device and a center button disposed in an inner sensing area of the sensing device.

### TECHNICAL FIELD

This invention relates to the field of user interface devices and, in particular, to touch-sensor devices.

### BACKGROUND

Computing devices, such as notebook computers, personal data assistants (PDAs), and mobile handsets, have user interface devices, which are also known as human interface devices (HID). One user interface device that has become more common is a touch-sensor pad (also commonly referred to as a touchpad). A basic notebook computer touch-sensor pad emulates the function of a personal computer (PC) mouse. A touch-sensor pad is typically embedded into a PC notebook for built-in portability. A touch-sensor pad replicates mouse x/y movement by using two defined axes which contain a collection of sensor elements that detect the position of a conductive object, such as a finger. Mouse right/left button clicks can be replicated by two mechanical buttons, located in the vicinity of the touchpad, or by tapping commands on the touch-sensor pad itself. The touch-sensor pad provides a user interface device for performing such functions as positioning a pointer, or selecting an item on a display. These touch-sensor pads may include multi-dimensional sensor arrays for detecting movement in multiple axes. The sensor array may include a one-dimensional sensor array, detecting movement in one axis. The sensor array may also be two dimensional, detecting movements in two axes.

One type of touchpad operates by way of capacitance sensing utilizing capacitive sensors. The capacitance detected by a capacitive sensor changes as a function of the proximity of a conductive object to the sensor. The conductive object can be, for example, a stylus or a user's finger. In a touch-sensor device, a change in capacitance detected by each sensor in the X and Y dimensions of the sensor array due to the proximity or movement of a conductive object can be measured by a variety of methods. Regardless of the method, usually an electrical signal representative of the capacitance detected by each capacitive sensor is processed by a processing device, which in turn produces electrical or optical signals representative of the position of the conductive object in relation to the touch-sensor pad in the X and Y dimensions. A touch-sensor strip, slider, or button operates on the same capacitance-sensing principle.

Another user interface device that has become more common is a touch screen. Touch screens, also known as touchscreens, touch panels, or touchscreen panels are display overlays which are typically either pressure-sensitive (resistive), electrically-sensitive (capacitive), acoustically-sensitive (SAW—surface acoustic wave) or photo-sensitive (infra-red). The effect of such overlays allows a display to be used as an input device, removing the keyboard and/or the mouse as the primary input device for interacting with the display's content. Such displays can be attached to computers or, as terminals, to networks. There are a number of types of touch screen technology, such as optical imaging, resistive, surface wave, capacitive, infrared, dispersive signal, and strain gauge technologies. Touch screens have become familiar in retail settings, on point of sale systems, on ATMs, on mobile handsets, on game consoles, and on PDAs where a stylus is sometimes used to manipulate the graphical user interface (GUI) and to enter data.

FIG. 1A illustrates a conventional touch-sensor pad. The touch-sensor pad 100 includes a sensing surface 101 on which a conductive object may be used to position a pointer in the x- and y-axes, using either relative or absolute positioning, or to select an item on a display. Touch-sensor pad 100 may also include two buttons, left and right buttons 102 and 103, respectively, shown here as an example. These buttons are typically mechanical buttons, and operate much like a left and right button on a mouse. These buttons permit a user to select items on a display or send other commands to the computing device.

FIG. 1B illustrates a conventional linear touch-sensor slider. The linear touch-sensor slider 110 includes a surface area 111 on which a conductive object may be used to position a pointer in the x-axis (or alternatively in any other axis, such as the y-axis). The construct of touch-sensor slider 110 may be the same as that of touch-sensor pad 100. Touch-sensor slider 110 may include a sensor array capable of detection in only one dimension (referred to herein as one-dimensional sensor array). The slider structure may include one or more sensor elements that may be conductive traces. By positioning or manipulating a conductive object in contact or in proximity to a particular portion of the slider structure, the capacitance between each conductive line and ground varies and can be detected. The capacitance variation may be sent as a signal on the conductive line to a processing device. It should also be noted that the sensing may be performed in a differential fashion, obviating the need for a ground reference. For example, by detecting the relative capacitance of each sensor element, the position and/or motion (if any) of the external conductive object can be pinpointed. In one embodiment, it can be determined which sensor element has detected the presence of the conductive object, and it can also be determined the motion and/or the position of the conductive object over multiple sensor elements.

One difference between touch-sensor sliders and touch-sensor pads may be how the signals are processed after detecting the conductive objects. Another difference is that the touch-sensor slider is not necessarily used to convey absolute positional information of a conducting object (e.g., to emulate a mouse in controlling pointer positioning on a display), but rather relative positional information. However, the touch-sensor slider and touch-sensor pad may be configured to support either relative or absolute coordinates, and/or to support one or more touch-sensor button functions of the sensing device.

FIG. 1C illustrates a conventional sensing device having three touch-sensor buttons. Conventional sensing device 120 includes button 121, button 122, and button 123. These buttons may be capacitive touch-sensor buttons. These three buttons may be used for user input using a conductive object, such as a finger.

FIG. 1D illustrates a conventional circular slider having a center mechanical button within the circular slider. Circular slider 120 includes eight sensor elements 122(1)-122(8), disposed in a toroidal-shaped configuration, and a mechanical button 121, disposed within the toroid of sensor elements 122(1)-122(8). The eight sensor elements 122(1)-122(8) are coupled to eight pins of processing device 120 via eight signal lines 123(1)-123(8). The mechanical button 121 is also coupled to a pin of the processing device 120 via signal line 124. Circular sliders are also known as closed-cycle sliders because the first sensor element (e.g., 122(1)) of a group of sensor elements is disposed to be adjacent to the last sensor element (e.g., 122(8)) of the group, which in effect closes the group of sensor elements into a cycle.

In this conventional circular slider, an extra pin on the processing device 120 is required to provide button operation functionality in addition to the slider functionality of the sensing device.

Like linear sliders, circular sliders may be used to convey absolute or relative positional information of a conductive object, such as to emulate a mouse in controlling pointer positioning on a display, or to emulate a scrolling function of the mouse, but may also be used to actuate one or more functions associated with the sensing elements of the sensing device. By sensing the variation of the capacitance on a circular slider, the finger position on slider may be located.

The sensor elements and the middle mechanical button of this conventional design are disposed on the same top layer of a printed circuit board (PCB).

### BRIEF DESCRIPTION OF THE DRAWINGS

The present invention is illustrated by way of example, and not by way of limitation, in the figures of the accompanying drawings.

FIG. 1A illustrates a conventional touch-sensor pad.

FIG. 1B illustrates a conventional linear touch-sensor slider.

FIG. 1C illustrates a conventional sensing device having three touch-sensor buttons.

FIG. 1D illustrates a conventional circular slider having a center mechanical button within the circular slider.

FIG. 2 illustrates a block diagram of one embodiment of an electronic system having a processing device for detecting a presence of a conductive object.

FIG. 3A illustrates a varying capacitance sensor element.

FIG. 3B illustrates one embodiment of a capacitance sensor element coupled to a processing device.

FIG. 3C illustrates one embodiment of a relaxation oscillator for measuring a capacitance on a sensor element.

FIG. 3D illustrates a schematic of one embodiment of a circuit including a sigma-delta modulator and a digital filter for measuring capacitance on a sensor element.

FIG. 4 illustrates a block diagram of one embodiment of an electronic device including a processing device that includes capacitance sensor for measuring the capacitance on a sensor array.

FIG. 5A illustrates a top-side view of one embodiment of a sensing device having a circular slider disposed on a bottom layer and a center button disposed on a top layer of a circuit board and a grounded conductor surrounding the center button on the top layer.

FIG. 5B illustrates a bottom-side view of the embodiment of FIG. 5A.

FIG. 6A illustrates a top-side view of one embodiment of a grounded conductor disposed in a first layer of a sensing device having a circular slider and a center button.

FIG. 6B illustrates a top-side view of another embodiment of a grounded conductor disposed in a first layer of a sensing device having a circular slider and a center button.

FIG. 6C illustrates a top-side view of another embodiment of a grounded conductor disposed in a first layer of a sensing device having a circular slider and a center button.

FIG. 6D illustrates a top-side view of another embodiment of a grounded conductor disposed in a first layer of a sensing device having a circular slider and a center button.

FIG. 6E illustrates a top-side view of another embodiment of a grounded conductor disposed in a first layer of a sensing device having a circular slider and a center button.

FIG. 7A illustrates a top-side view of one embodiment of a circular slider having eight sensor elements.

FIG. 7B illustrates a top-side view of one embodiment of a circular slider having sixteen sensor elements.

FIG. 7C illustrates a top-side view of one embodiment of a circular slider having five sensor elements.

FIG. 8A illustrates a cross-sectional view of one embodiment of a two-layer sensing device.

FIG. 8B illustrates a cross-sectional view of one embodiment of a three-layer sensing device.

FIG. 8C illustrates a cross-sectional view of one embodiment of a four-layer sensing device.

FIG. 8D illustrates a cross-sectional view of one embodiment of a one-layer sensing device.

FIG. 9A illustrates a cross-sectional view of one embodiment of the circuit board of FIGS. 5A and 5B having a grounded conductor coupled to the processing device using a via.

FIG. 9B illustrates a cross-sectional view of another embodiment of a circuit board having a grounded conductor coupled to the processing device using a spring metal clip.

FIG. 10 illustrates top- and bottom-side views of one embodiment of a sensing device having a circular slider disposed on a bottom layer and a center button disposed on a top layer of a circuit board and without a grounded conductor surrounding the center button on the top layer.

FIG. 11 illustrates a flow chart of one embodiment of a method for detecting a presence of a conductive object on the sensing device.

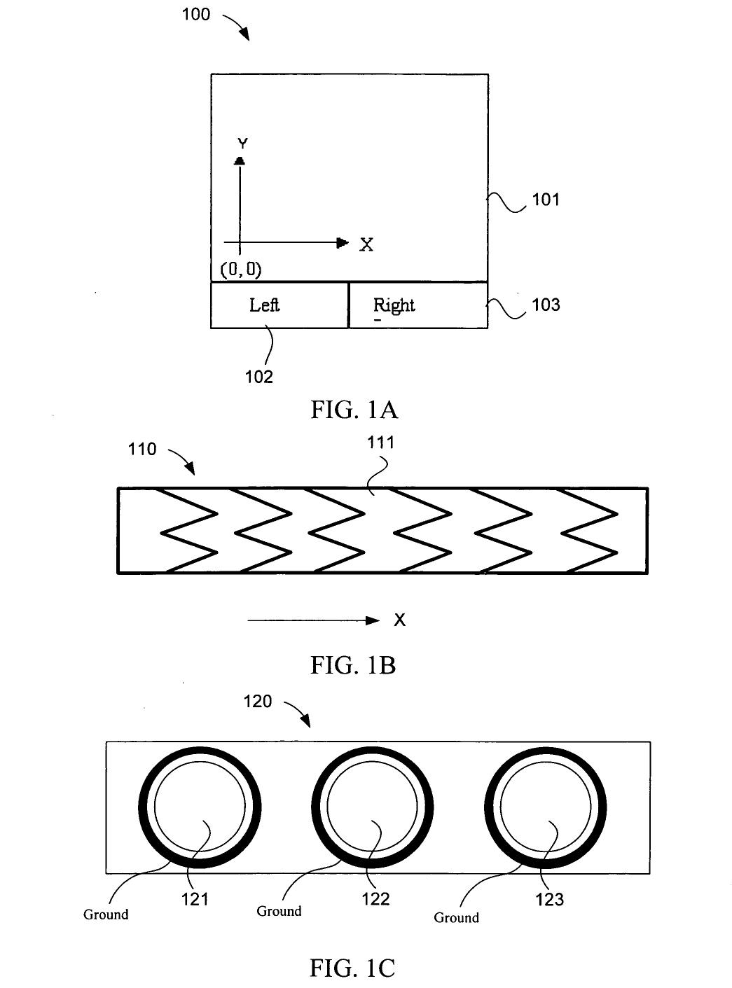

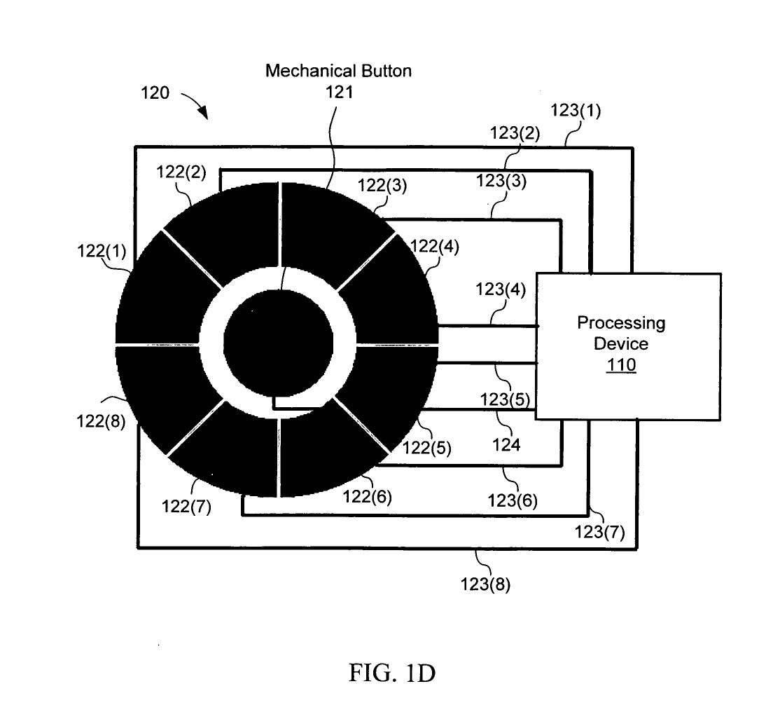

### DETAILED DESCRIPTION

Described herein is a method and apparatus having a plurality of non-linearly disposed sensor elements disposed in an outer sensing area and an additional sensor element disposed in the inner sensing area. The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the spirit and scope of the present invention.

In one embodiment, the apparatus may include a sensing device having an outer sensing area and an inner sensing area. The sensing device includes a plurality of non-linearly disposed sensor elements disposed in the outer sensing area and an additional sensor element disposed in the inner sensing area. The inner sensing area is located within the outer sensing area of the plurality of sensor elements. In one embodiment, the method may include detecting a presence of a conductive object, manipulated by a user, on the sensing device. In another embodiment, the plurality of non-linearly disposed sensor elements are disposed in a first layer (e.g., bottom layer) and portions of the sensing areas of the plurality of non-linearly disposed sensor elements are located within the inner sensing area. The additional sensor element is disposed in second layer (e.g., top layer) of the circuit board. In another embodiment, the apparatus further includes a grounded conductor disposed to surround the additional sensor element in the second layer to shield the portions of the sensing areas of the plurality of non-linearly disposed sensor elements in the first layer that are located within the inner sensing area. In one embodiment, the grounded conductor is disposed on the second layer of the circuit board. Alternatively, the grounded conductor is disposed on a separate layer or separate plane than the layer within which the plurality of sensor elements are disposed.

In another embodiment, the apparatus includes a processing device coupled to the plurality of sensor elements and the additional sensor element, and is configured to connect the plurality of sensor elements to a system ground while sensing the additional sensor element to measure a capacitance on the additional sensor element. This embodiment does not include a grounded conductor to surround the additional sensor element in the second layer.

The embodiments described herein include a circular slider having a center button in the center of the circular slider. The sensor elements of the circular slider may be disposed in one layer, and the sensor elements of the center button are disposed on a separate plane in the same layer, or in a separate layer as the sensor elements of the circular slider. For example, in a two-layer PCB, the sensor elements of the circular slider are disposed in a bottom layer and the sensor element of the center button is disposed on a top layer. The center button may be a touch-sensor button, including a sensor element, or alternatively, the center button may be a mechanical button.

In another embodiment, a grounded conductor, such as a circular ground pad is disposed on the top layer of the PCB to shield the sensing area of the sensor elements of the circular slider that are disposed on the bottom layer. Alternatively, a processing device coupled to the center button and the circular slider is configured to connect the sensor elements of the circular slide to a system ground, while sensing the capacitance on the sensor element of the center button.

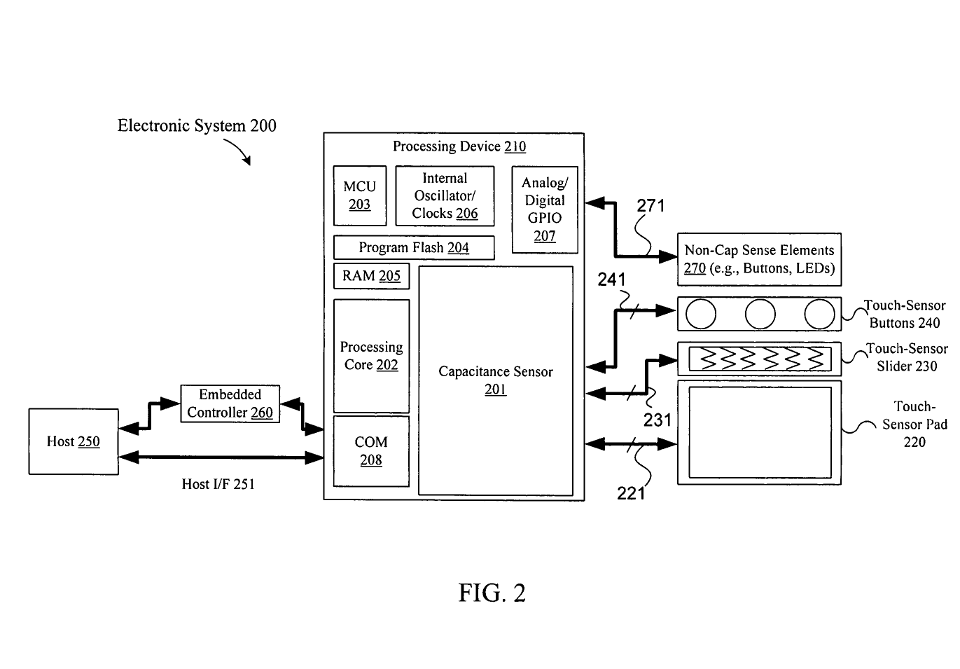

FIG. 2 illustrates a block diagram of one embodiment of an electronic system having a processing device for detecting a presence of a conductive object. Electronic system 200 includes processing device 210, touch-sensor pad 220, touch-sensor slider 230, touch-sensor buttons 240, host processor 250, embedded controller 260, and non-capacitance sensor elements 270. The processing device 210 may include analog and/or digital general purpose input/output (“GPIO”) ports 207. GPIO ports 207 may be programmable. GPIO ports 207 may be coupled to a Programmable Interconnect and Logic (“PIL”), which acts as an interconnect between GPIO ports 207 and a digital block array of the processing device 210 (not illustrated). The digital block array may be configured to implement a variety of digital logic circuits (e.g., DAC, digital filters, digital control systems, etc.) using, in one embodiment, configurable user modules (“UMs”). The digital block array may be coupled to a system bus (not illustrated). Processing device 210 may also include memory, such as random access memory (RAM) 205 and program flash 204. RAM 205 may be static RAM (SRAM) or the like, and program flash 204 may be a non-volatile storage, or the like, which may be used to store firmware (e.g., control algorithms executable by processing core 202 to implement operations described herein). Processing device 210 may also include a memory controller unit (MCU) 203 coupled to memory and the processing core 202.

The processing device 210 may also include an analog block array (not illustrated). The analog block array is also coupled to the system bus. Analog block array also may be configured to implement a variety of analog circuits (e.g., ADC, analog filters, etc.) using, in one embodiment, configurable UMs. The analog block array may also be coupled to the GPIO 207.

As illustrated, capacitance sensor 201 may be integrated into processing device 210. Capacitance sensor 201 may include analog I/O for coupling to an external component, such as touch-sensor pad 220, touch-sensor slider 230, touch-sensor buttons 240, and/or other devices. Capacitance sensor 201 and processing device 202 are described in more detail below.

It should be noted that the embodiments described herein are not limited to touch-sensor buttons (e.g., capacitance sensing button), but can be used in other capacitive sensing implementations, for example, the sensing device may be a touch screen, a touch-sensor slider 230, or a touch-sensor pad 220. It should also be noted that the embodiments described herein may be implemented in other sensing technologies than capacitive sensing, such as resistive, optical imaging, surface wave, infrared, dispersive signal, and strain gauge technologies. Similarly, the operations described herein are not limited to notebook pointer operations, but can include other operations, such as lighting control (dimmer), volume control, graphic equalizer control, speed control, or other control operations requiring gradual or discrete adjustments. It should also be noted that these embodiments of capacitive sensing implementations may be used in conjunction with non-capacitive sensing elements, including but not limited to pick buttons, sliders (ex. display brightness and contrast), scroll-wheels, multi-media control (ex. volume, track advance, etc) handwriting recognition and numeric keypad operation.

The electronic system 200 includes a touch-sensor pad 220 coupled to the processing device 210 via bus 221. Touch-sensor pad 220 may include a two-dimension sensor array. The two-dimension sensor array includes multiple sensor elements, organized as rows and columns. The electronic system 200 includes a touch-sensor slider 230 coupled to the processing device 210 via bus 231. Touch-sensor slider 230 may include a single-dimension sensor array. The single-dimension sensor array includes multiple sensor elements, organized as rows, or alternatively, as columns. The electronic system 200 includes touch-sensor buttons 240 coupled to the processing device 210 via bus 241. Touch-sensor button 240 may include a single-dimension or multi-dimension sensor array. The single- or multi-dimension sensor array includes multiple sensor elements. For a touch-sensor button, the sensor elements may be coupled together to detect a presence of a conductive object over the entire surface of the touch panel. Alternatively, the touch-sensor button 240 has a single sensor element to detect the presence of the conductive object. In one embodiment, the touch-sensor button 240 may be a capacitance sensor element. Capacitance sensor elements may be used as non-contact sensor element. These sensor elements, when protected by an insulating layer, offer resistance to severe environments.

The electronic system 200 may include any combination of one or more of the touch-sensor pad 220, touch-sensor slider 230, and/or touch-sensor button 240. In another embodiment, the electronic system 200 may also include non-capacitance sensor elements 270 coupled to the processing device 210 via bus 271. The non-capacitance sensor elements 270 may include mechanical buttons, light emitting diodes (LEDs), and other user interface devices, such as a mouse, a keyboard, or other functional keys that do not require capacitance sensing. In one embodiment, buses 271, 241, 231, and 221 may be a single bus. Alternatively, these buses may be configured into any combination of one or more separate buses.

The processing device may also provide value-added functionality such as keyboard control integration, LEDs, battery charger and general purpose I/O, as illustrated as non-capacitance sensor elements 270. Non-capacitance sensor elements 270 are coupled to the GPIO 207.

Processing device 210 may include internal oscillator/clocks 206 and communication block 208. The oscillator/clocks block 206 provides clock signals to one or more of the components of processing device 210. Communication block 208 may be used to communicate with an external component, such as a host processor 250, via host interface (I/F) line 251. Alternatively, processing block 210 may also be coupled to embedded controller 260 to communicate with the external components, such as host 250. Interfacing to the host 250 can be through various methods. In one exemplary embodiment, interfacing with the host 250 may be done using a standard PS/2 interface to connect to an embedded controller 260, which in turn sends data to the host 250 via a low pin count (LPC) interface. In some instances, it may be beneficial for the processing device 210 to do both touch-sensor pad and keyboard control operations, thereby freeing up the embedded controller 260 for other housekeeping functions. In another exemplary embodiment, interfacing may be done using a universal serial bus (USB) interface directly coupled to the host 250 via host interface line 251. Alternatively, the processing device 210 may communicate to external components, such as the host 250 using industry standard interfaces, such as USB, PS/2, inter-integrated circuit (I2C) bus, or system packet interfaces (SPI). The host 250 and/or embedded controller 260 may be coupled to the processing device 210 with a ribbon or flex cable from an assembly, which houses the sensing device and processing device.

In one embodiment, the processing device 210 is configured to communicate with the embedded controller 260 or the host 250 to send and/or receive data. The data may be a command or alternatively a signal. In an exemplary embodiment, the electronic system 200 may operate in both standard-mouse compatible and enhanced modes. The standard-mouse compatible mode utilizes the HID class drivers already built into the Operating System (OS) software of host 250. These drivers enable the processing device 210 and sensing device to operate as a standard pointer control user interface device, such as a two-button PS/2 mouse. The enhanced mode may enable additional features such as scrolling or disabling the sensing device, such as when a mouse is plugged into the notebook. Alternatively, the processing device 210 may be configured to communicate with the embedded controller 260 or the host 250, using non-OS drivers, such as dedicated touch-sensor pad drivers, or other drivers known by those of ordinary skill in the art.

In one embodiment, the processing device 210 may operate to communicate data (e.g., commands or signals) using hardware, software, and/or firmware, and the data may be communicated directly to the processing device of the host 250, such as a host processor, or alternatively, may be communicated to the host 250 via drivers of the host 250, such as OS drivers, or other non-OS drivers. It should also be noted that the host 250 may directly communicate with the processing device 210 via host interface 251.

In one embodiment, the data sent to the host 250 from the processing device 210 includes click, double-click, movement of the pointer, scroll-up, scroll-down, scroll-left, scroll-right, step Back, and step Forward. In another embodiment, the data sent to the host 250 include the position or location of the conductive object on the sensing device. Alternatively, other user interface device commands may be communicated to the host 250 from the processing device 210. These commands may be based on gestures occurring on the sensing device that are recognized by the processing device, such as tap, push, hop, drag, and zigzag gestures. Alternatively, other commands may be recognized. Similarly, signals may be sent that indicate the recognition of these operations.

In particular, a tap gesture, for example, may be when the finger (e.g., conductive object) is on the sensing device for less than a threshold time. If the time the finger is placed on the touchpad is greater than the threshold time it may be considered to be a movement of the pointer, in the x- or y-axes. Scroll-up, scroll-down, scroll-left, and scroll-right, step back, and step-forward may be detected when the absolute position of the conductive object is within a pre-defined area, and movement of the conductive object is detected. In another embodiment, the touch-sensor button may be activated when a capacitance of a sensor element of the touch-sensor button exceeds a presence threshold. Alternatively, the touch-sensor button may be activated when a tap gesture is recognized on the touch-sensor button.

Processing device 210 may reside on a common carrier substrate such as, for example, an integrated circuit (IC) die substrate, a multi-chip module substrate, or the like. Alternatively, the components of processing device 210 may be one or more separate integrated circuits and/or discrete components. In one exemplary embodiment, processing device 210 may be a Programmable System on a Chip (PSoC™) processing device, manufactured by Cypress Semiconductor Corporation, San Jose, Calif. Alternatively, processing device 210 may be one or more other processing devices known by those of ordinary skill in the art, such as a microprocessor or central processing unit, a controller, special-purpose processor, digital signal processor (DSP), an application specific integrated circuit (ASIC), a field programmable gate array (FPGA), or the like. In an alternative embodiment, for example, the processing device may be a network processor having multiple processors including a core unit and multiple microengines. Additionally, the processing device may include any combination of general-purpose processing device(s) and special-purpose processing device(s).

It should also be noted that the embodiments described herein are not limited to having a configuration of a processing device coupled to a host, but may include a system that measures the capacitance on the sensing device and sends the raw data to a host computer where it is analyzed by an application. In effect the processing that is done by processing device 210 may also be done in the host.

In one embodiment, the method and apparatus described herein may be implemented in a fully self-contained sensing device (including the processing device), which outputs fully processed x/y movement and gesture data signals or data commands to a host. In another embodiment, the method and apparatus may be implemented in be a sensing device, which outputs positional data, gesture data, and/or finger presence data to a host, and where the host processes the received data to detect gestures. In another embodiment, the method and apparatus may be implemented in a sensing device, which outputs raw capacitance data to a host, where the host processes the capacitance data to compensate for quiescent and stray capacitance, and calculates positional information, detects the presence of the conductive object and/or detects gestures by processing the capacitance data. Alternatively, the method and apparatus may be implemented in a sensing device, which outputs pre-processed capacitance data to a host, where the sensing device processes the capacitance data to compensate for quiescent and stray capacitance, and the host calculates positional information, detects presence of the conductive object, and/or detects gestures from the pre-processed capacitance data.

Capacitance sensor 201 may be integrated into the processing device 210, or alternatively, in a separate IC. Alternatively, descriptions of capacitance sensor 201 may be generated and compiled for incorporation into other integrated circuits. For example, behavioral level code describing capacitance sensor 201, or portions thereof, may be generated using a hardware descriptive language, such as VHDL or Verilog, and stored to a machine-accessible medium (e.g., Flash ROM, CD-ROM, hard disk, floppy disk, etc.). Furthermore, the behavioral level code can be compiled into register transfer level (“RTL”) code, a netlist, or even a circuit layout and stored to a machine-accessible medium. The behavioral level code, the RTL code, the netlist, and the circuit layout all represent various levels of abstraction to describe capacitance sensor 201.

It should be noted that the components of electronic system 200 may include all the components described above. Alternatively, electronic system 200 may include only some of the components described above, or include additional components not listed herein.

In one embodiment, electronic system 200 may be used in a notebook computer. Alternatively, the electronic device may be used in other applications, such as a mobile handset, a personal data assistant (PDA), a keyboard, a television, a remote control, a monitor, a handheld multi-media device, a handheld video player, a handheld gaming device, or a control panel.

In one embodiment, capacitance sensor 201 may be a capacitive switch relaxation oscillator (CSR). The CSR may be coupled to an array of sensor elements using a current-programmable relaxation oscillator, an analog multiplexer, digital counting functions, and high-level software routines to compensate for environmental and physical sensor element variations. The sensor array may include combinations of independent sensor elements, sliding sensor elements (e.g., touch-sensor slider), and touch-sensor sensor element pads (e.g., touch pad) implemented as a pair of orthogonal sliding sensor elements. The CSR may include physical, electrical, and software components. The physical component may include the physical sensor element itself, typically a pattern constructed on a printed circuit board (PCB) with an insulating cover, a flexible membrane, or a transparent overlay. The electrical component may include an oscillator or other means to convert a charged capacitance into a measured signal. The electrical component may also include a counter or timer to measure the oscillator output. The software component may include detection and compensation software algorithms to convert the count value into a sensor element detection decision (also referred to as switch detection decision). For example, in the case of slider sensor elements or X-Y touch-sensor sensor element pads, a calculation for finding position of the conductive object to greater resolution than the physical pitch of the sensor elements may be used.

It should be noted that there are various known methods for measuring capacitance. Although some embodiments described herein are described using a relaxation oscillator, the present embodiments are not limited to using relaxation oscillators, but may include other methods, such as current versus voltage phase shift measurement, resistor-capacitor charge timing, capacitive bridge divider, charge transfer, sigma-delta modulators, charge-accumulation circuits, or the like.

The current versus voltage phase shift measurement may include driving the capacitance through a fixed-value resistor to yield voltage and current waveforms that are out of phase by a predictable amount. The drive frequency can be adjusted to keep the phase measurement in a readily measured range. The resistor-capacitor charge timing may include charging the capacitor through a fixed resistor and measuring timing on the voltage ramp. Small capacitance values may require very large resistors for reasonable timing. The capacitive bridge divider may include driving the capacitor under test through a fixed reference capacitor. The reference capacitor and the capacitor under test form a voltage divider. The voltage signal is recovered with a synchronous demodulator, which may be done in the processing device 210. The charge transfer may be conceptually similar to an R-C charging circuit. In this method, C_{P} is the capacitance being sensed. C_{SUM} is the summing capacitor, into which charge is transferred on successive cycles. At the start of the measurement cycle, the voltage on C_{SUM} is reset. The voltage on C_{SUM} increases exponentially (and only slightly) with each clock cycle. The time for this voltage to reach a specific threshold is measured with a counter. Additional details regarding these alternative embodiments have not been included so as to not obscure the present embodiments, and because these alternative embodiments for measuring capacitance are known by those of ordinary skill in the art.

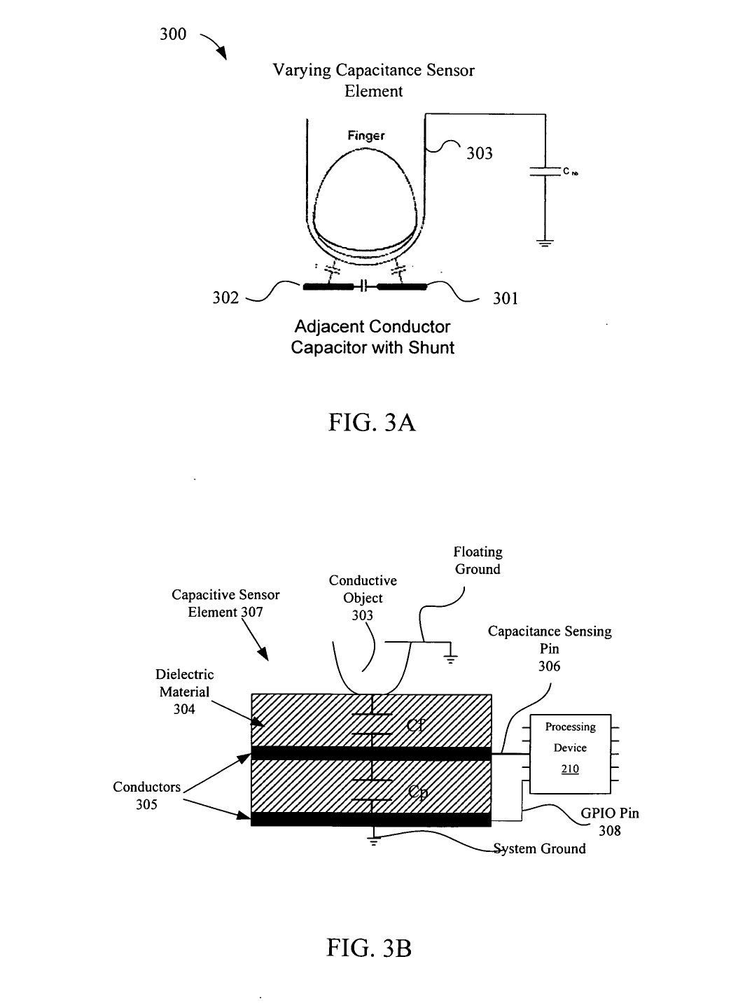

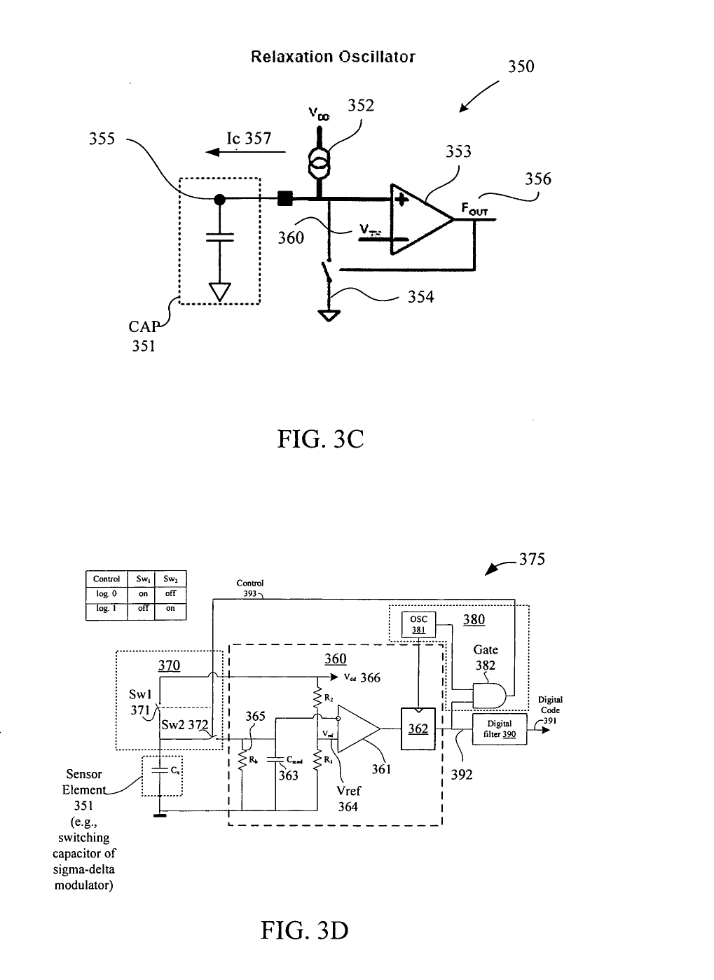

FIG. 3A illustrates a varying capacitance sensor element. In its basic form, a capacitance sensor element 300 is a pair of adjacent conductors 301 and 302. There is a small edge-to-edge capacitance, but the intent of sensor element layout is to minimize the parasitic capacitance Cp between these conductors. When a conductive object 303 (e.g., finger) is placed in proximity to the two conductor 301 and 302, there is a capacitance between electrode 301 and the conductive object 303 and a similar capacitance between the conductive object 303 and the other electrode 302. The capacitance between the electrodes when no conductive object 303 is present is the base capacitance Cp that may be stored as a baseline value. There is also a total capacitance (Cp+Cf) on the sensor element 300 when the conductive object 303 is present on or in close proximity to the sensor element 300. The baseline capacitance value Cp may be subtracted from the total capacitance when the conductive object 303 is present to determine the change in capacitance (e.g., capacitance variation Cf) when the conductive object 303 is present and when the conductive object 303 is not present on the sensor element. Effectively, the capacitance variation Cf can be measured to determine whether a conductive object 303 is present or not (e.g., sensor activation) on the sensor element 300.

Capacitance sensor element 300 may be used in a capacitance sensor array. The capacitance sensor array is a set of capacitors where one side of each capacitor is connected to a system ground. When the capacitance sensor element 300 is used in the sensor array, when the conductor 301 is sensed, the conductor 302 is connected to ground, and when the conductor 302 is sensed, the conductor 301 is connected to ground. Alternatively, when the sensor element is used for a touch-sensor button, the sensor element is sensed and the sensed button area is surrounded by a fixed ground. The presence of the conductive object 303 increases the capacitance (Cp+Cf) of the sensor element 300 to ground. Determining sensor element activation is then a matter of measuring change in the capacitance (Cf) or capacitance variation. Sensor element 300 is also known as a grounded variable capacitor.

The conductive object 303 in this embodiment has been illustrated as a finger. Alternatively, this technique may be applied to any conductive object, for example, a conductive door switch, position sensor, or conductive pen in a stylus tracking system (e.g., stylus).

The capacitance sensor element 300 is known as a projected capacitance sensor. Alternatively, the capacitance sensor element 300 may be a surface capacitance sensor that does not make use of rows or columns, but instead makes use of a single linearized field, such as the surface capacitance sensor described in U.S. Pat. No. 4,293,734. The surface capacitance sensor may be used in touch screen applications.

FIG. 3B illustrates one embodiment of a capacitance sensor element 307 coupled to a processing device 210. Capacitance sensor element 307 illustrates the capacitance as seen by the processing device 210 on the capacitance sensing pin 306. As described above, when a conductive object 303 (e.g., finger) is placed in proximity to one of the conductors 305, there is a capacitance, Cf, between the one of the conductors 305 and the conductive object 303 with respect to ground. This ground, however, may be a floating ground. Also, there is a capacitance, Cp, between the conductors 305, with one of the conductors 305 being connected to a system ground. The grounded conductor may be coupled to the processing device 210 using GPIO pin 308. The conductors 305 may be metal, or alternatively, the conductors may be conductive ink (e.g., carbon ink) or conductive polymers. In one embodiment, the grounded conductor may be an adjacent sensor element. Alternatively, the grounded conductor may be other grounding mechanisms, such as a surrounding ground plane. Accordingly, the processing device 210 can measure the change in capacitance, capacitance variation Cf, as the conductive object is in proximity to one of the conductors 305. Above and below the conductor that is closest to the conductive object 303 is dielectric material 304. The dielectric material 304 above the conductor 305 can be an overlay, as described in more detail below. The overlay may be non-conductive material used to protect the circuitry from environmental conditions and ESD, and to insulate the user's finger (e.g., conductive object) from the circuitry. Capacitance sensor element 307 may be a sensor element of a touch-sensor pad, a touch-sensor slider, or a touch-sensor button.

FIG. 3C illustrates one embodiment of a relaxation oscillator for measuring a capacitance on a sensor element 351. The relaxation oscillator 350 is formed by the capacitance to be measured on sensor element 351 (represented as capacitor 351), a charging current source 352, a comparator 353, and a reset switch 354 (also referred to as a discharge switch). It should be noted that capacitor 351 is representative of the capacitance measured on a sensor element. The sensor element and the one or more surrounding grounded conductors may be metal, or alternatively, the conductors may be conductive ink (e.g., carbon ink) or conductive polymers. The relaxation oscillator is coupled to drive a charging current (Ic) 357 in a single direction onto a device under test (“DUT”) capacitor, capacitor 351. As the charging current piles charge onto the capacitor 351, the voltage across the capacitor increases with time as a function of Ic 357 and its capacitance C. Equation (1) describes the relation between current, capacitance, voltage, and time for a charging capacitor.

CdV=I_{C}dt (1)

The relaxation oscillator begins by charging the capacitor 351, at a fixed current Ic 357, from a ground potential or zero voltage until the voltage across the capacitor 351 at node 355 reaches a reference voltage or threshold voltage, V_{TH} 360. At the threshold voltage V_{TH} 360, the relaxation oscillator allows the accumulated charge at node 355 to discharge (e.g., the capacitor 351 to “relax” back to the ground potential) and then the process repeats itself. In particular, the output of comparator 353 asserts a clock signal F_{OUT} 356 (e.g., F_{OUT} 356 goes high), which enables the reset switch 354. This discharges the voltage on the capacitor at node 355 to ground and the charge cycle starts again. The relaxation oscillator outputs a relaxation oscillator clock signal (F_{OUT} 356) having a frequency (f_{RO}) dependent upon capacitance C of the capacitor 351 and charging current Ic 357.

The comparator trip time of the comparator 353 and reset switch 354 add a fixed delay. The output of the comparator 353 is synchronized with a reference system clock to guarantee that the reset time is long enough to completely discharge capacitor 351. This sets a practical upper limit to the operating frequency. For example, if capacitance C of the capacitor 351 changes, then f_{RO} changes proportionally according to Equation (1). By comparing f_{RO} of F_{OUT} 356 against the frequency (f_{REF}) of a known reference system clock signal (REF CLK), the change in capacitance (AC) can be measured. Accordingly, equations (2) and (3) below describe that a change in frequency between F_{OUT} 356 and REF CLK is proportional to a change in capacitance of the capacitor 351.

ΔC∞Δf, where (2)

Δf=f_{RO}−f_{REF}. (3)

In one embodiment, a frequency comparator may be coupled to receive relaxation oscillator clock signal (F_{OUT} 356) and REF CLK, compare their frequencies f_{RO} and f_{REF}, respectively, and output a signal indicative of the difference Δf between these frequencies. By monitoring Δf one can determine whether the capacitance of the capacitor 351 has changed.

In one exemplary embodiment, the relaxation oscillator 350 may be built using a programmable timer to implement the comparator 353 and reset switch 354. Alternatively, the relaxation oscillator 350 may be built using other circuiting. Relaxation oscillators are known by those of ordinary skill in the art, and accordingly, additional details regarding their operation have not been included so as to not obscure the present embodiments. The capacitor charging current for the relaxation oscillator 350 may be generated in a register programmable current output DAC (also known as IDAC). Accordingly, the current source 352 may be a current DAC or IDAC. The IDAC output current may be set by an 8-bit value provided by the processing device 210, such as from the processing core 202. The 8-bit value may be stored in a register or in memory.

In many capacitance sensor element designs, the two “conductors” of the sensing capacitor are actually adjacent sensor elements that are electrically isolated (e.g., PCB pads or traces). Typically, one of these conductors is connected to a system ground. Layouts for touch-sensor slider (e.g., linear slide sensor elements) and touch-sensor pad applications have sensor elements that may be immediately adjacent. In these cases, all of the sensor elements that are not active are connected to a system ground through the GPIO 207 of the processing device 210 dedicated to that pin. The actual capacitance between adjacent conductors is small (Cp), but the capacitance of the active conductor (and its PCB trace back to the processing device 210) to ground, when detecting the presence of the conductive object 303, may be considerably higher (Cp+Cf). The capacitance of two adjacent conductors is given by the following equation:

$$C = {ɛ}_{0} \cdot {ɛ}_{R} \cdot \frac{A}{d} = {ɛ}_{R} \cdot 8.85 \cdot \frac{A}{d} p F / m \qquad ( 4 )$$

The dimensions of equation (4) are in meters. This is a very simple model of the capacitance. The reality is that there are fringing effects that substantially increase the sensor element-to-ground (and PCB trace-to-ground) capacitance.

Sensor element sensitivity (i.e., activation distance) may be increased by one or more of the following: 1) increasing board thickness to increase the distance between the active sensor element and any parasitics; 2) minimizing PCB trace routing underneath sensor elements; 3) utilizing a gridded ground with 50% or less fill if use of a ground plane is absolutely necessary; 4) increasing the spacing between sensor element pads and any adjacent ground plane; 5) increasing pad area; 6) decreasing thickness of any insulating overlay; 7) using higher dielectric constant material in the insulating overlay; or 8) verifying that there is no air-gap between the PC pad surface and the touching finger.

There is some variation of sensor element sensitivity as a result of environmental factors. A baseline update routine, which compensates for this variation, may be provided in the high-level APIs.

As described above with respect to the relaxation oscillator 350, when a finger or conductive object is placed on the sensor element, the capacitance increases from Cp to Cp+Cf so the relaxation oscillator output signal 356 (F_{OUT}) decreases. The relaxation oscillator output signal 356 (F_{OUT}) may be fed to a digital counter for measurement. There are two methods for counting the relaxation oscillator output signal 356: frequency measurement and period measurement. Additional details of the relaxation oscillator and digital counter are known by those of ordinary skill in the art, and accordingly a detailed description regarding them have not been included. It should also be noted, that the embodiments described herein are not limited to using relaxation oscillators, but may include other sensing circuitry for measuring capacitance, such as versus voltage phase shift measurement, resistor-capacitor charge timing, capacitive bridge divider, charge transfer, sigma-delta modulators, charge-accumulation circuits, or the like.

FIG. 3D illustrates a schematic of one embodiment of a circuit 375 including a sigma-delta modulator 360 and a digital filter 390 for measuring capacitance on a sensor element 351. Circuit 375 includes a switching circuit 370, switching clock source 380, sigma-delta modulator 360, and digital filter 390 for measuring the capacitance on sensor element 351. Sensor element 351 may be a used for a touch-sensor button, and is represented as a switching capacitor Cx in the modulator feedback loop. Switching circuit 370 includes two switches Sw₁ 371 and Sw₂ 372. The switches Sw₁ 371 and Sw₂ 372 operate in two, non-overlapping phases (also known as break-before-make configuration). These switches together with sensing capacitor Cₓ 351 form the switching capacitor equivalent resistor, which provides the modulator capacitor C_{mod} 363 of sigma-delta modulator 360 charge current (as illustrated in FIG. 3D) or discharge current (not illustrated) during one of the two phases.

The sigma-delta modulator 360 includes the comparator 361, latch 362, modulator capacitor C_{mod} 363, modulator feedback resistor 365, which may also be referred to as bias resistor 365, and voltage source 366. The output of the comparator may be configured to toggle when the voltage on the modulator capacitor 363 crosses a reference voltage 364. The reference voltage 364 may be a pre-programmed value, and may be configured to be programmable. The sigma-delta modulator 360 also includes a latch 362 coupled to the output of the comparator 361 to latch the output of the comparator 361 for a given amount of time, and provide as an output, output 392. The latch may be configured to latch the output of the comparator based on a clock signal from the gate circuit 382 (e.g., oscillator signal from the oscillator 381). In another embodiment, the sigma-delta modulator 360 may include a synchronized latch that operates to latch an output of the comparator for a pre-determined length of time. The output of the comparator may be latched for measuring or sampling the output signal of the comparator 361 by the digital filter 390.

Sigma-delta modulator 360 is configured to keep the voltage on the modulator capacitor 363 close to reference voltage V_{ref} 364 by alternatively connecting the switching capacitor resistor (e.g., switches Sw₁ 371 and Sw₂ 372 and sensing capacitor Cₓ 351) to the modulator capacitor 363. The output 392 of the sigma-delta modulator 360 (e.g., output of latch 362) is feedback to the switching clock circuit 380, which controls the timing of the switching operations of switches Sw₁ 371 and Sw₂ 372 of switching circuit 370. For example, in this embodiment, the switching clock circuit 380 includes an oscillator 381 and gate 382. Alternatively, the switching clock circuit 380 may include a clock source, such as a spread spectrum clock source (e.g., pseudo-random signal (PRS)), a frequency divider, a pulse width modulator (PWM), or the like. The output 392 of the sigma-delta modulator 360 is used with an oscillator signal to gate a control signal 393, which switches the switches Sw₁ 371 and Sw₂ 372 in a non-overlapping manner (e.g., two, non-overlapping phases). The output 392 of the sigma-delta modulator 360 is also output to digital filter 430, which filters and/or converts the output into the digital code 391.

In one embodiment of the method of operation, at power on, the modulator capacitor 363 has zero voltage and switching capacitor resistor (formed by sensing capacitor Cx 351, and switches Sw₁ 371 and Sw₂ 372) is connected between Vdd line 366 and modulator capacitor 363. This connection allows the voltage on the modulator capacitor 363 to rise. When this voltage reaches the comparator reference voltage, V_{ref} 364, the comparator 361 toggles and gates the control signal 393 of the switches Sw₁ 371 and Sw₂ 372, stopping the charge current. Because the current via bias resistors R_{b} 365 continues to flow, the voltage on modulator capacitor 363 starts dropping. When it drops below the reference voltage 364, the output of the comparator 361 switches again, enabling the modulator 363 to start charging. The latch 362 and the comparator 361 set sample frequency of the sigma-delta modulator 360.

The digital filter 390 is coupled to receive the output 392 of the sigma-delta modulator 360. The output 392 of the sigma-delta modulator 360 may be a single bit bit-stream, which can be filtered and/or converted to the numerical values using a digital filter 390. In one embodiment, the digital filter 390 is a counter. In another embodiment, the standard Sinc digital filter can be used. In another embodiment, the digital filter is a decimator. Alternatively, other digital filters may be used for filtering and/or converting the output 392 of the sigma-delta modulator 360 to provide the digital code 391. It should also be noted that the output 392 may be output to the decision logic 402 or other components of the processing device 210, or to the decision logic 451 or other components of the host 250 to process the bitstream output of the sigma-delta modulator 360.

Described below are the mathematical equations that represent the operations of FIG. 3D. During a normal operation mode, the sigma-delta modulator 360 keeps these currents equal in the average by keeping the voltage on the modulator 363 equal to, or close to, the reference voltage V_{ref} 364. The current of the bias resistor R_{b} 365 is:

$${I}_{Rb} = \frac{{V}_{c mod}}{{R}_{b}} \qquad ( 5 )$$

The sensing capacitor Cₓ 351 in the switched-capacitor mode has equivalent resistance:

$${R}_{c} = \frac{1}{{f}_{s} {C}_{x}} \qquad ( 6 )$$

where fₛ is the operation frequency of the switches (e.g., switching circuit 370). If the output 392 of the sigma-delta modulator 360 has a duty cycle of d_{mod}, the average current of the switching capacitor 351 can be expressed in the following equation (7):

$${I}_{c} = {d}_{mod} \frac{{V}_{dd} - {V}_{C mod}}{{R}_{c}} \qquad ( 7 )$$

### In the operation mode,

$${I}_{Rb} = {I}_{c} , {V}_{C mod} = {V}_{ref} \text{or:} \frac{{V}_{ref}}{{R}_{b}} = {d}_{mod} \frac{{V}_{dd} - {V}_{ref}}{{R}_{c}} \qquad ( 8 )$$

or taking into account that the reference voltage 364 is part of supply voltage:

$${V}_{ref} = {k}_{d} {V}_{dd} ; {k}_{d} = \frac{{R}_{1}}{{R}_{1} + {R}_{2}} \qquad ( 9 )$$

The Equation (5) can be rewritten in the following form:

$${d}_{mod} = \frac{{R}_{c}}{{R}_{b}} \frac{{k}_{d}}{1 - {k}_{d}} = \frac{1}{{f}_{s} {R}_{b}} \frac{{k}_{d}}{1 - {k}_{d}} \frac{1}{{C}_{x}} \qquad ( 10 )$$

The Equation (10) determines the minimum sensing capacitance value, which can be measured with the proposed method at given parameters set:

$${d}_{mod} \leq 1 , \text{or:} {C}_{x min} = \frac{1}{{f}_{s} {R}_{b}} \frac{{k}_{d}}{1 - {k}_{d}} \qquad ( 11 )$$

The resolution of this method may be determined by the sigma-delta modulator duty cycle measurement resolution, which is represented in the following equations:

$$Δ {d}_{mod} = β \frac{Δ {C}_{x}}{{C}_{x}^{2}} ; \\ β = \frac{1}{{f}_{s} {R}_{b}} \frac{{k}_{d}}{1 - {k}_{d}} \qquad ( 12 )$$

or after rewriting relatively ΔCₓ, we obtain:

$$Δ {C}_{x} = \frac{1}{β} Δ {d}_{mod} {C}_{x}^{2} \qquad ( 13 )$$

In one exemplary embodiment, the resistance of the bias resistor 365 is 20K Ohms (R_{b}=20k), the operation frequency of the switches is 12 MHz (fₛ=12 MHz), the capacitance on the switching capacitor 351 is 15 picofarads (Cₓ=15 pF), and the ratio between Vdd 366 and the voltage reference 364 is 0.25 (k_{d}=0.25), the duty cycle has a 12-bit resolution and the capacitance resolution is 0.036 pF.

In some embodiments of capacitive sensing applications, it may be important to get fast data measurements. For example, the modulator can operate at sample frequency 10 MHz (period is 0.1 microseconds (us)), for the 12-bit resolution sample, and digital filter as single-type integrator/counter the measurement time is approximately 410 us (e.g., 2¹²*0.1 us=410us). For faster measurement speeds at same resolutions, other types of digital filters may be used, for example, by using the Sinc2 filter, the sensing time at the same resolution may be reduced approximately 4 times. To do this the sensing method should have suitable measurement speed. In one embodiment, a good measurement rate may be accomplished by using a double integrator as the digital filter 390.

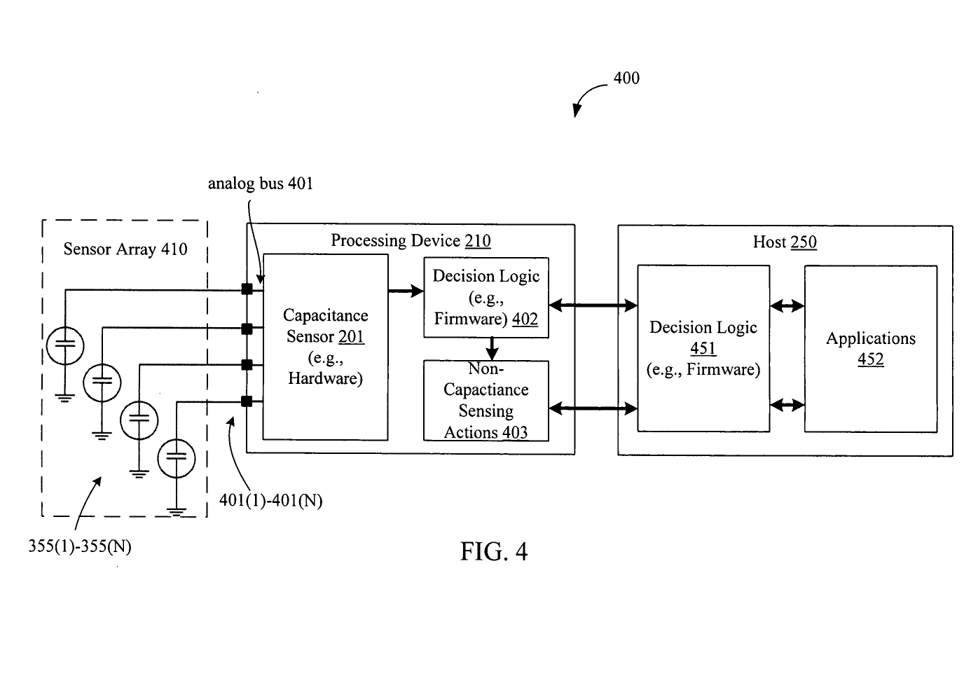

FIG. 4 illustrates a block diagram of one embodiment of an electronic device 400 including a processing device that includes capacitance sensor 201 for measuring the capacitance on a sensor array 410. The electronic device 400 of FIG. 4 includes a sensor array 410, processing device 210, and host 250. Sensor array 410 includes sensor elements 355(1)-355(N), where N is a positive integer value that represents the number of rows (or alternatively columns) of the sensor array 410. Each sensor element is represented as a capacitor, as described above with respect to FIG. 3B. The sensor array 410 is coupled to processing device 210 via an analog bus 401 having multiple pins 401(1)-401(N). In one embodiment, the sensor array 410 may be a single-dimension sensor array including the sensor elements 355(1)-355(N), where N is a positive integer value that represents the number of sensor elements of the single-dimension sensor array. The single-dimension sensor array 410 provides output data to the analog bus 401 of the processing device 210 (e.g., via lines 231). Alternatively, the sensor array 410 may be a two-dimension sensor array including the sensor elements 355(1)-355(N), where N is a positive integer value that represents the number of sensor elements of the two-dimension sensor array. The two-dimension sensor array 410 provides output data to the analog bus 401 of the processing device 210 (e.g., via bus 221).

In one embodiment, the capacitance sensor 201 includes a selection circuit (not illustrated). The selection circuit is coupled to the sensor elements 355(1)-355(N) and the sensing circuitry of the capacitance sensor 201. Selection circuit may be used to allow the capacitance sensor to measure capacitance on multiple sensor elements (e.g., rows or columns). The selection circuit may be configured to sequentially select a sensor element of the multiple sensor elements to provide the charge current and to measure the capacitance of each sensor element. In one exemplary embodiment, the selection circuit is a multiplexer array. Alternatively, selection circuit may be other circuitry inside or outside the capacitance sensor 201 to select the sensor element to be measured. In another embodiment, one capacitance sensor 201 may be used to measure capacitance on all of the sensor elements of the sensor array. Alternatively, multiple capacitance sensors 201 may be used to measure capacitance on the sensor elements of the sensor array. The multiplexer array may also be used to connect the sensor elements that are not being measured to the system ground. This may be done in conjunction with a dedicated pin in the GP10 port 207.

In another embodiment, the capacitance sensor 201 may be configured to substantially simultaneously sense the sensor elements, as opposed to being configured to sequentially sense the sensor elements as described above. For example, the sensing device may include a sensor array having multiple rows and columns. The rows may be sensed substantially simultaneously, and the columns may be sensed substantially simultaneously.

In one exemplary embodiment, the voltages on all of the rows of the sensor array are simultaneously varied, while the voltages of the columns are held at a constant voltage, with the complete set of sampled points simultaneously giving a profile of the conductive object in a first dimension. Next, the voltages on all of the rows are held constant, while the voltages on all the rows are simultaneously varied, to obtain a complete set of sampled points simultaneously giving a profile of the conductive object in the other dimension.

In another exemplary embodiment, the voltages on all of the rows of the sensor array are simultaneously varied in a positive direction, while the voltages of the columns are varied in a negative direction. Next, the voltages on all of the rows of the sensor array are simultaneously varied in a negative direction, while the voltages of the columns are varied in a positive direction. This technique doubles the effect of any transcapacitance between the two dimensions, or conversely, halves the effect of any parasitic capacitance to the ground. In both methods, the capacitive information from the sensing process provides a profile of the presence of the conductive object to the sensing device in each dimension. Alternatively, other methods for sensing known by those of ordinary skill in the art may be used to sense the sensing device.

In one embodiment, the processing device 210 further includes a decision logic block 402. The operations of decision logic block 402 may be implemented in firmware; alternatively, it may be implemented in hardware or software. The decision logic block 402 may be configured to receive the digital code or counts from the capacitance sensor 201, and to determine the state of the sensor array 410, such as whether a conductive object is detected on the sensor array, where the conductive object was detected on the sensor array (e.g., determining the X-, Y-coordinates of the presence of the conductive object), determining absolute or relative position of the conductive object, whether the conductive object is performing a pointer operation, whether a gesture has been recognized on the sensor array 410 (e.g., click, double-click, movement of the pointer, scroll-up, scroll-down, scroll-left, scroll-right, step Back, step Forward, tap, push, hop, zigzag gestures, or the like), or the like.

In another embodiment, instead of performing the operations of the decision logic 402 in the processing device 210, the processing device 201 may send the raw data to the host 250, as described above. Host 250, as illustrated in FIG. 4, may include decision logic 451. The operations of decision logic 451 may also be implemented in firmware, hardware, and/or software. Also, as described above, the host may include high-level APIs in applications 452 that perform routines on the received data, such as compensating for sensitivity differences, other compensation algorithms, baseline update routines, start-up and/or initialization routines, interpolations operations, scaling operations, or the like. The operations described with respect to the decision logic 402 may be implemented in decision logic 451, applications 452, or in other hardware, software, and/or firmware external to the processing device 210.

In another embodiment, the processing device 210 may also include a non-capacitance sensing actions block 403. This block may be used to process and/or receive/transmit data to and from the host 250. For example, additional components may be implemented to operate with the processing device 210 along with the sensor array 410 (e.g., keyboard, keypad, mouse, trackball, LEDs, displays, or the like).

At startup (or boot) the sensor elements (e.g., capacitors 355(1)-(N)) are sensed and the count values for each sensor element with no activation are stored as a baseline array (Cp). The presence of a finger on the sensor element is determined by the difference in counts between a stored value for no sensor element activation and the acquired value with sensor element activation, referred to here as Δn. The sensitivity of a single sensor element is approximately:

$$\frac{Δ n}{n} = \frac{Cf}{Cp} \qquad ( 14 )$$

The value of Δn should be large enough for reasonable resolution and clear indication of sensor element activation. This drives sensor element construction decisions. Cf should be as large a fraction of Cp as possible. Since Cf is determined by finger area and distance from the finger to the sensor element's conductive traces (through the over-lying insulator), the baseline capacitance Cp should be minimized. The baseline capacitance Cp includes the capacitance of the sensor element pad plus any parasitics, including routing and chip pin capacitance.

In sensor array applications, variations in sensitivity should be minimized. If there are large differences in Δn, one sensor element may activate at 1.0 cm, while another may not activate until direct contact. This presents a non-ideal user interface device. There are numerous methods for balancing the sensitivity. These may include precisely matching on-board capacitance with PCB trace length modification, adding balance capacitors on each sensor element's PCB trace, and/or adapting a calibration factor to each sensor element to be applied each time the sensor element is measured.

In one embodiment, the PCB design may be adapted to minimize capacitance, including thicker PCBs where possible. In one exemplary embodiment, a 0.062 inch thick PCB is used. Alternatively, other thicknesses may be used, for example, a 0.015 inch thick PCB.

Sliding sensor elements may be used for control requiring gradual or discrete adjustments. Examples include a lighting control (dimmer), volume control, graphic equalizer, and speed control. Slider controls may also be used for scrolling functions in menus of data. These sensor elements may be mechanically adjacent to one another. Activation of one sensor element results in partial activation of physically adjacent sensor elements. The actual position in the sliding sensor element is found by computing the centroid location of the set of sensor elements activated.

In applications for touch-sensor sliders (e.g., sliding sensor elements) and touch-sensor pads it is often necessary to determine finger (or other capacitive object) position to greater resolution than the native pitch of the individual sensor elements. The contact area of a finger on a sliding sensor element or a touch-pad is often larger than any single sensor element. In one embodiment, in order to calculate the interpolated position using a centroid, the array is first sensed to verify that a given sensor element location is valid. The requirement is for some number of adjacent sensor element signals to be above a noise threshold. When the strongest signal is found, this signal and those immediately adjacent are used to compute a centroid:

$$Centroid = \frac{{n}_{i - 1} \cdot ( i - 1 ) + {n}_{i} i + {n}_{i + 1} \cdot ( i + 1 )}{{n}_{i - 1} + {n}_{i} i + {n}_{i + 1}} \qquad ( 15 )$$

The calculated value may be fractional. In order to report the centroid to a specific resolution, for example a range of 0 to 100 for 12 sensor elements, the centroid value may be multiplied by a calculated scalar. It may be more efficient to combine the interpolation and scaling operations into a single calculation and report this result directly in the desired scale. This may be handled in the high-level APIs. Alternatively, other methods may be used to interpolate the position of the conductive object.

A physical sensing device assembly is a multi-layered module to detect a conductive object. In one embodiment, the multi-layer stack-up of a sensing device assembly includes a PCB, an adhesive layer, and an overlay. The PCB may include the processing device 210 and other components, such as the connector to the host 250, necessary for operations for sensing the capacitance. These components are on the non-sensing side of the PCB. The PCB also includes the sensor array on the opposite side; the sensing side of the PCB. Alternatively, other multi-layer stack-ups may be used in the sensing device assembly.

The PCB may be made of standard materials, such as FR4 or Kapton™ (e.g., flexible PCB). Alternatively, the PCB may be made of non-flexible PCB material. In either case, the processing device 210 may be attached (e.g., soldered) directly to the sensing PCB (e.g., attached to the non-sensing side of the PCB). The PCB thickness varies depending on multiple variables, including height restrictions and sensitivity requirements. In one embodiment, the PCB thickness is at least approximately 0.3 millimeters (mm). Alternatively, the PCB may have other thicknesses. It should be noted that thicker PCBs may yield improved sensitivity. The PCB length and width is dependent on individual design requirements for the device on which the sensing device is mounted, such as a notebook or mobile handset.

The adhesive layer may be directly on top of the PCB sensing array and is used to affix the overlay to the overall sensing device assembly. Typical material used for connecting the overlay to the PCB is non-conductive adhesive such as 3M 467 or 468. In one exemplary embodiment, the adhesive thickness is approximately 0.05 mm. Alternatively, the adhesive may be present on the bottom or back side of the overlay, and other thicknesses may be used.

The overlay may be non-conductive material used to protect the PCB circuitry from environmental conditions and ESD, and to insulate the user's finger (e.g., conductive object) from the circuitry. Overlay can be ABS plastic, polycarbonate, glass, or polyester film, such as Mylar™ polyester film. Alternatively, other materials known by those of ordinary skill in the art may be used. In one exemplary embodiment, the overlay has a thickness of approximately 1.0 mm. In another exemplary embodiment, the overlay thickness has a thickness of approximately 2.0 mm. Alternatively, other thicknesses may be used.

The sensor array may be a grid-like pattern of sensor elements (e.g., capacitive elements) used in conjunction with the processing device 210 to detect a presence of a conductive object, such as finger, to a resolution greater than that which is native. The touch-sensor pad layout pattern may be disposed to maximize the area covered by conductive material, such as copper, in relation to spaces necessary to define the rows and columns of the sensor array.

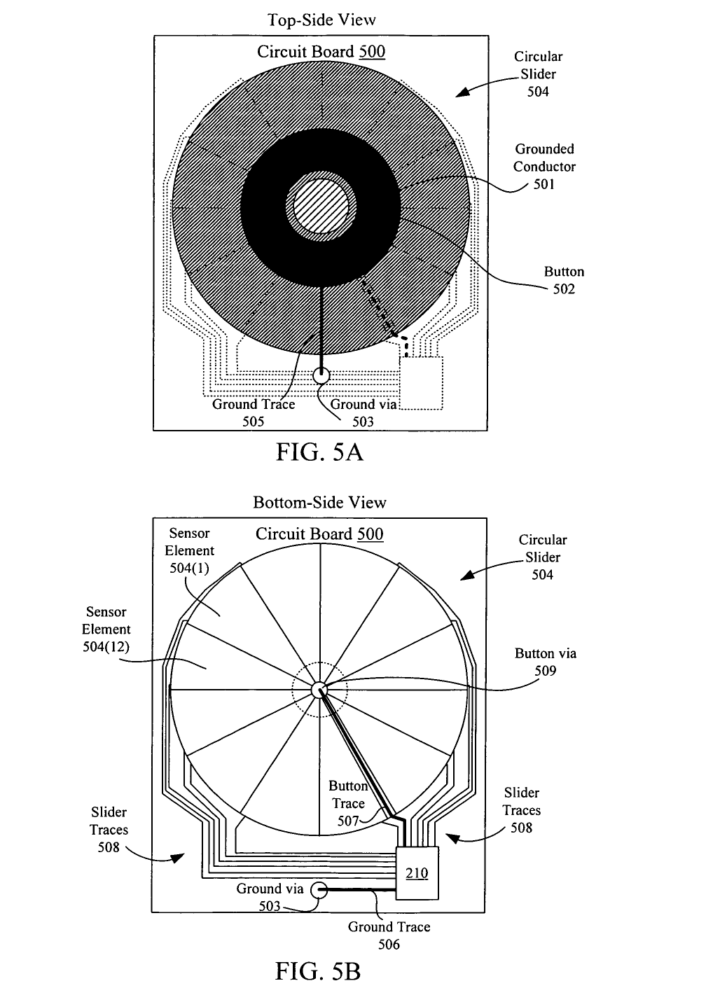

FIGS. 5A and 5B illustrate top- and bottom-side views of one embodiment of a sensing device having a circular slider 504 disposed on a bottom layer and a center button 502 disposed on a top layer of a circuit board 500 and a grounded conductor 501 surrounding the center button 502 on the top layer. The top-side view of FIG. 5A illustrates one side of a circuit board 500 of the sensing device. The center button 502 is disposed on the one side of the circuit board 500. The center button 502 may be a touch-sensor button or a mechanical button. The grounded conductor 501 is disposed to surround the center button 502 on the top layer. The grounded conductor 501 and the center button are electrically isolated. In one embodiment, isolation material is disposed between the center button 502 and the grounded conductor 501 to electrically isolate them from one another. Alternatively, the center button 502 and the grounded conductor 501 are disposed to have a distance between them, creating an air gap between the conductors. The grounded conductor 501 is connected to a system ground of the processing device 210. This may be done using a ground trace 505 and/or a ground via 503. The grounded conductor 501, center button 502, and ground trace 505 are all disposed on the top side of circuit board 500.

On the bottom-side of the circuit board 500 of the sensing device, the circular slider 504, including the non-linearly disposed sensor element 504(1)-(12), and the processing device 210 are disposed, as illustrated in FIG. 5B. It should be noted that the top-side view of FIG. 5A illustrates the sensor elements 504(1)-(12) of the circular slider 504, the slider traces 508, and the processing device 210; however, these have been illustrated with hashed lines and dotted lines to indicate that they are disposed on the bottom side of the circuit board 500. The sensor elements 504(1)-(12) are pie-shaped, having a circular outer perimeter and two sides that converge substantially to a point in the center of the circular slider. Alternatively, the sensor elements may have other shapes and may be disposed in other non-linear configurations. Similarly, the center button may be other shapes than a circle. Each of the sensor elements 504(1)-(12) are coupled to the processing device 210 using interconnecting traces, slider traces 580. The center button 502 is coupled to the processing device 210 using an interconnecting trace, button trace 507. The button trace 507 is electrically isolated from the sensor elements 504(7) and 504(8), and may be disposed in other configurations on the same layer (e.g., separate planes of the same layer) or on a different layer of the circuit board 500. The button trace 507 may be coupled to the center button 502 through a via, button via 509, from the top side to the bottom side of the circuit board 500. The grounded conductor 501 is also coupled to the processing device 210 through a via, ground via 503, which couples the ground trace 505 on the top side and ground trace 506 of the bottom side of the circuit board 500.

The sensing device, as illustrated in FIG. 5A, includes an outer sensing area and an inner sensing area. The twelve non-linearly disposed sensor elements 504(1)-(12) are disposed in the outer sensing area in a circle. Since the sensor elements are pie shaped, extending from the outer sensing area to the inner sensing area, portions of the sensing areas of the sensor elements 504(1)-(12) are located within the inner sensing area of the sensing device. The center button 502 is also disposed in the inner sensing area of the sensing device, but in a different plane or layer than the sensing elements 504(1)-(12). In one embodiment, the center button 502 is a touch-sensor button and includes a sensor element. This sensor element is a different sensor element than the sensor elements 504(1)-(12). Because the touch-sensor button is disposed on the top side of the circuit board 500 and the sensor elements 504(1)-(12) are disposed on the bottom side of the circuit board 500, the sensor elements of the circular slider and the center button are electrically isolated. Also, in this embodiment, the grounded conductor 501 is disposed in the same layer as the center button 502. The grounded conductor 501 is configured to shield the portions of the sensing area of the sensor element 504(1)-(12) that are located within the inner sensing area. In another embodiment, the grounded conductor 501 is disposed on a separate layer of the circuit board 500 than the layers that include the sensor elements of the circular slider and the touch-sensor button.

In another embodiment, circuit board 500 does not include the grounded conductor 501, and the processing device 210 is configured to connect some or all of the sensor elements 504(1)-(12) to a system ground, while sensing the sensor element of the center button 502. For example, the center button 502 includes a sensor element and the processing device 210 is configured to connect the sensor elements 504(1)-(12) to a system ground of the processing device 210, while the sensor element is sensed to measure a capacitance on the sensor element of the center button 502.

In one embodiment, the processing device 210 is configured to detect the presence of a conductive object, manipulated by a user, on the sensing device. The processing device 210 may be configured to determine a button operation when the presence of the conductive object is detected on the inner sensing area of the sensing device that corresponds to the center button 502, and a slider operation when the presence of the conductive object is detected on the outer sensing area of the sensing device that corresponds to the sensor elements 504(1)-(12). The processing device 210 may also be configured to determine an absolute or relative position of the conductive object on the inner or outer sensing area of the sensing device.

As described above, the processing device 210 may be configured to sequentially or substantially simultaneously sense the capacitance on each of the sensor element 504(1)-(12) and the sensor element of the center button 502. Alternatively, the processing device 210 may be configured to sequentially sense the capacitance on each of the sensor elements 504(1)-(12) and the sensor element of the center button 502, and to connect the sensor elements 504(1)-(12) to a system ground while the sensor element of the center button 502 is sensed.

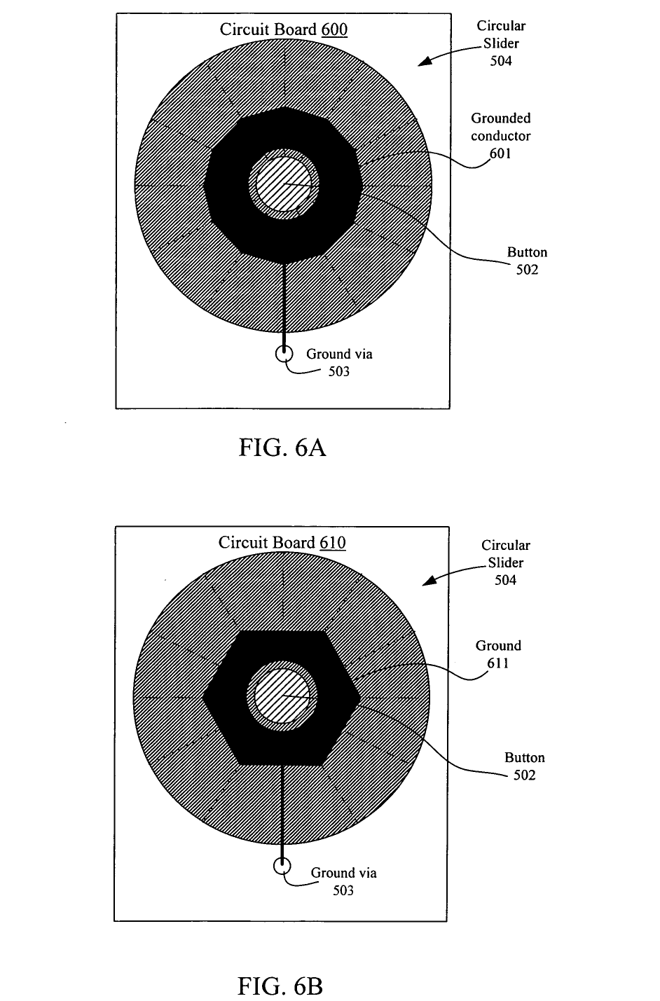

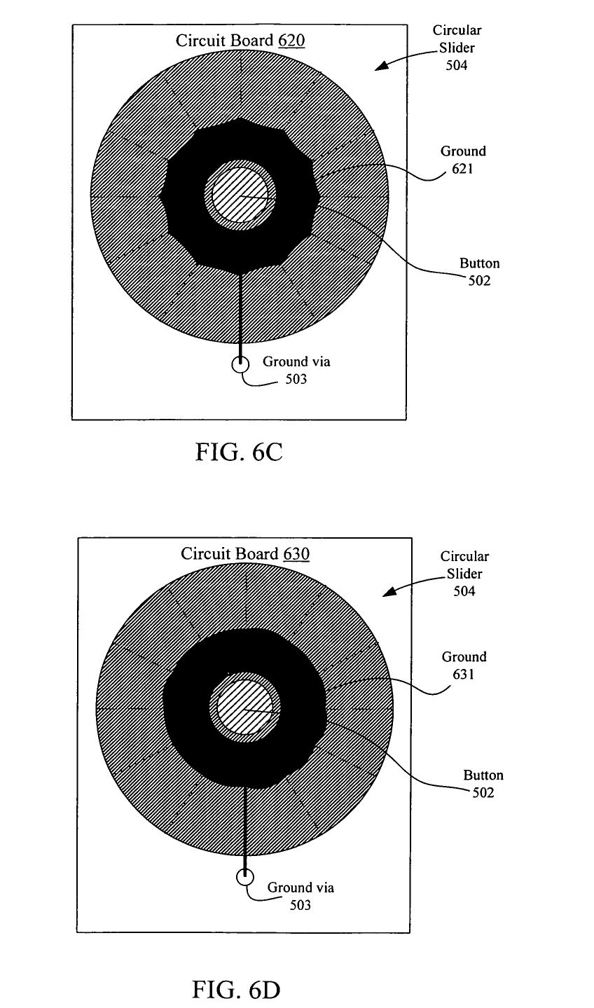

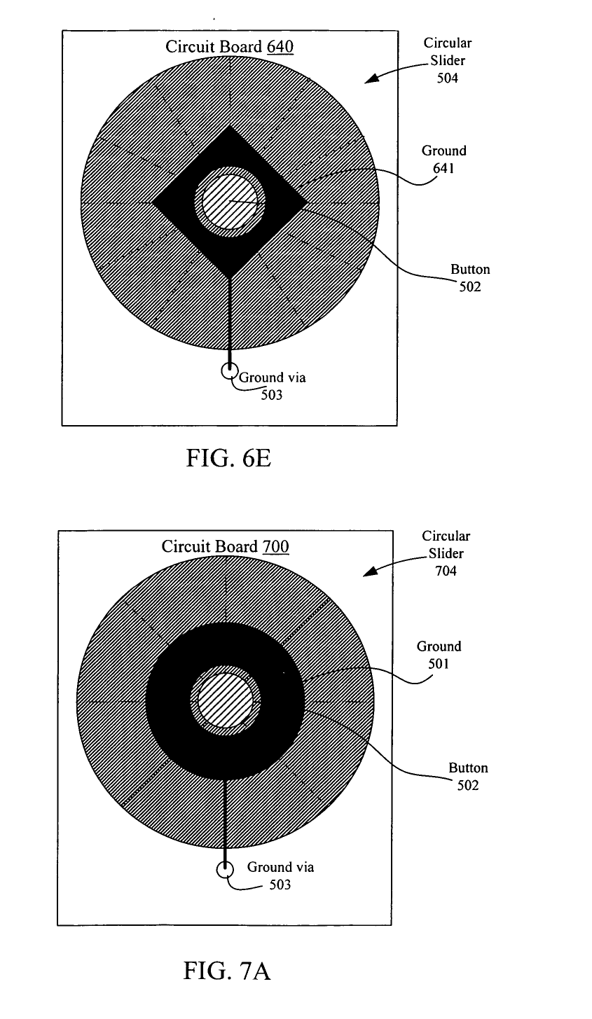

Although the grounded conductor 501 of FIG. 5A is a ground plane having a circular shape, the grounded conductor 501 may have other shapes, such as illustrated in FIG. 6A-6E.

FIG. 6A illustrates a top-side view of one embodiment of a grounded conductor 601 disposed in a first layer of a sensing device having a circular slider 504 and a center button 502. Grounded conductor 601 is disposed on the top side of the circuit board 600. Circuit board 600 is similar to the circuit board 500, except for shape of the grounded conductor disposed on the top side. Grounded conductor 601, instead of having a circular shape, has a twelve sided shape, having twelve-straight edges on the outer perimeter and a circular center opening within which the center button 502 is disposed.

FIG. 6B illustrates a top-side view of another embodiment of a grounded conductor 611 disposed in a first layer of a sensing device having a circular slider 504 and a center button 502. Circuit board 610 is similar to the circuit board 600, except for shape of the grounded conductor disposed on the top side. Grounded conductor 611, instead of having a circular shape, has a six-sided shape, having six straight edges on the outer perimeter and a circular center opening within which the center button 502 is disposed.

FIG. 6C illustrates a top-side view of another embodiment of a grounded conductor 621 disposed in a first layer of a sensing device having a circular slider 504 and a center button 502. Circuit board 620 is similar to the circuit board 600, except for shape of the grounded conductor disposed on the top side. Grounded conductor 621, instead of having a circular shape, has a twelve-sided shape, having twelve convex curved edges on the outer perimeter and a circular center opening within which the center button 502 is disposed.

FIG. 6D illustrates a top-side view of another embodiment of a grounded conductor 631 disposed in a first layer of a sensing device having a circular slider 504 and a center button 502. Circuit board 630 is similar to the circuit board 600, except for shape of the grounded conductor disposed on the top side. Grounded conductor 631, instead of having a circular shape, has a twelve-sided shape, having twelve concave curved edges on the outer perimeter and a circular center opening within which the center button 502 is disposed.

FIG. 6E illustrates a top-side view of another embodiment of a grounded conductor 641 disposed in a first layer of a sensing device having a circular slider 504 and a center button 502. Circuit board 640 is similar to the circuit board 600, except for shape of the grounded conductor disposed on the top side. Grounded conductor 641, instead of having a circular shape, has a four-sided shape, having four straight edges on the outer perimeter and a circular center opening within which the center button 502 is disposed.

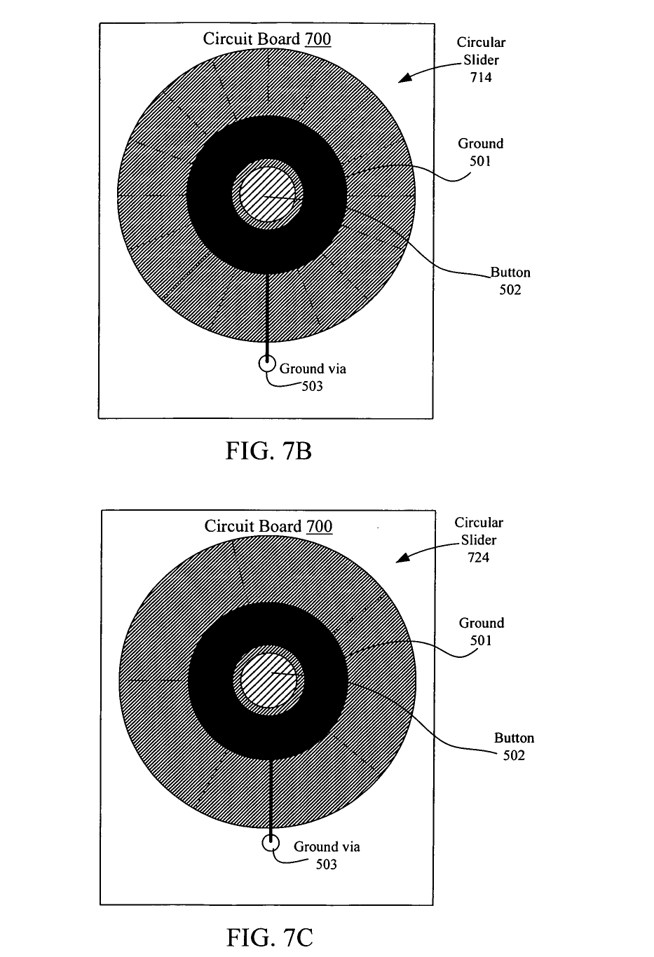

Although the grounded conductors 601-641 are illustrated as having a circular center opening within which the center button 502 is disposed, the grounded conductors 601-641 may include other shapes of the center opening. In addition, the grounded conductor may have other shapes than those illustrated in FIGS. 6A-6E. Similarly, although the circular sliders 504 are illustrated in FIGS. 6A-6E as having twelve sensor elements, the circular slider may include five or more non-linearly disposed sensor elements. In one embodiment, the circular slider 704 includes eight sensor elements, as illustrated in FIG. 7A. In another embodiment, the circular slider 714 includes sixteen sensor elements, as illustrated in FIG. 7B. In another embodiment, the circular slider 724 includes five sensor elements, as illustrated in FIG. 7C. Alternatively, the circular slider includes five or more sensor elements to detect the presence of a conductive object on the sensing device. Similarly, although the center button 502 has been illustrated as circular, other shapes may be used for the center button.

As previously described, the sensing device may be disposed on a single layer circuit board, or alternatively, on a multi-layer circuit board, such as a two-layer, a four-layer, a three-layer, or the like.

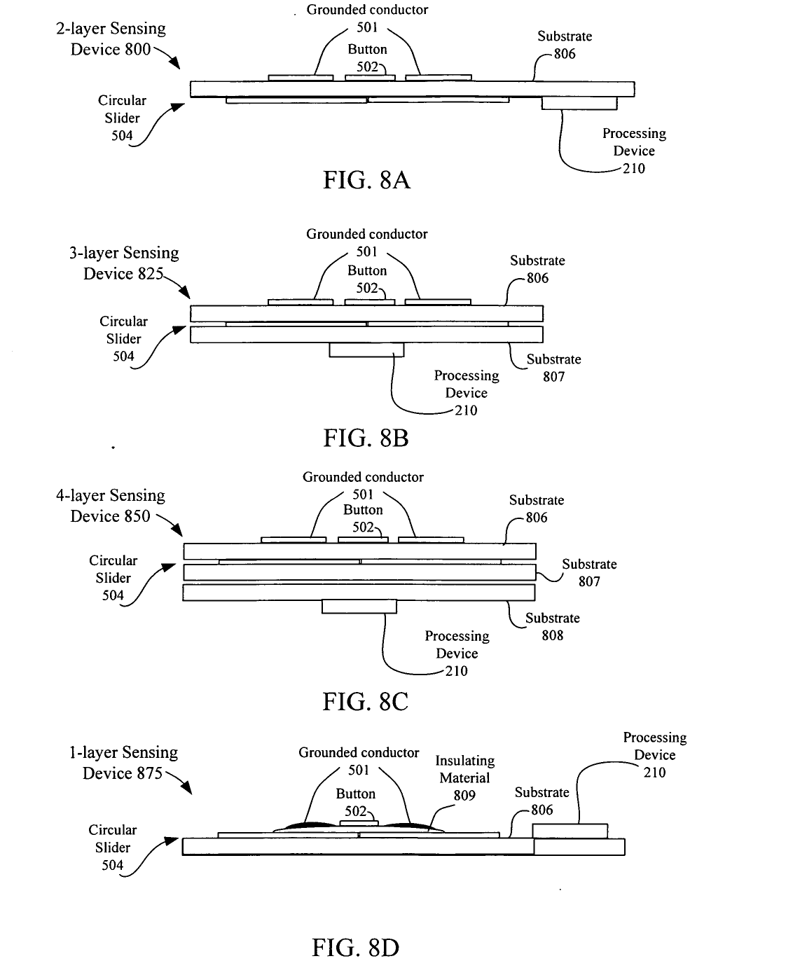

FIG. 8A illustrates a cross-sectional view of one embodiment of a two-layer sensing device 800. The two-layer sensing device 800 includes a substrate 806, the circular slider 504, center button 502, processing device 210, and grounded conductor 501. The grounded conductor 501 and center button 502 are disposed on the substrate 806 in a top layer of the two-layer sensing device 800. The sensor elements (e.g., 504(1)-(12)) of the circular slider 504 and the processing device 210 are disposed on the substrate 806 in a bottom layer of the two-layer sensing device 800. The grounded conductor 501 is disposed on the top layer to shield portions of the sensing area of the sensor elements that are disposed on the bottom layer. The remaining portions of the sensing areas of the sensor elements are configured to operate as a circular slider 504 having an effective opening in the sensor elements within which the center button 502 is disposed. The design described herein effectively results in similar configuration as the conventional circular slider described above, but the sensor elements are pie-shaped, extending into the inner sensing area of the sensing device.

In another embodiment, the two-layer sensing device 800 does not include the grounded conductor 501 and the processing device 210 is configured to connect the sensor elements of the circular slider 504 to a system ground of the processing device 210, while sensing the sensor element of the center button 502 to measure a capacitance on a sensor element of the center button 502.

FIG. 8B illustrates a cross-sectional view of one embodiment of a three-layer sensing device 825. The three-layer sensing device 825 includes a first substrate 806, a second substrate 807, the circular slider 504, center button 502, processing device 210, and grounded conductor 501. The grounded conductor 501 and center button 502 are disposed on the first substrate 806 in a top layer of the three-layer sensing device 825. The sensor elements (e.g., 504(1)-(12)) of the circular slider 504 are disposed between the first and second substrates 806 and 807 in a middle layer of the three-layer sensing device 825. The processing device 210 is disposed on the second substrate 807 in a bottom layer of the three-layer sensing device 825. The grounded conductor 501 is disposed on the top layer to shield portions of the sensing area of the sensor elements that are disposed on the middle layer. The remaining portions of the sensing areas of the sensor elements are configured to operate as a circular slider 504 having an effective opening in the sensor elements within which the center button 502 is disposed.

In another embodiment, the three-layer sensing device 825 does not include the grounded conductor 501 and the processing device 210 is configured to connect the sensor elements of the circular slider 504 to a system ground of the processing device 210, while sensing the sensor element of the center button 502 to measure a capacitance on a sensor element of the center button 502.

FIG. 8C illustrates a cross-sectional view of one embodiment of a four-layer sensing device 850. The four-layer sensing device 850 includes a first substrate 806, a second substrate 807, a third substrate 808, the circular slider 504, center button 502, processing device 210, and grounded conductor 501. The grounded conductor 501 and center button 502 are disposed on the first substrate 806 in a top layer of the four-layer sensing device 850. The sensor elements (e.g., 504(1)-(12)) of the circular slider 504 are disposed between the first and second substrates 806 and 807 in one of the middle layers of the four-layer sensing device 850. The processing device 210 is disposed on the third substrate 808 in a bottom layer of the four-layer sensing device 850. The second and third substrates 807 and 808 are coupled together. The grounded conductor 501 is disposed on the top layer to shield portions of the sensing area of the sensor elements that are disposed on the middle layer. The remaining portions of the sensing areas of the sensor elements are configured to operate as a circular slider 504 having an effective opening in the sensor elements within which the center button 502 is disposed.

In another embodiment, the four-layer sensing device 850 does not include the grounded conductor 501 and the processing device 210 is configured to connect the sensor elements of the circular slider 504 to a system ground of the processing device 210, while sensing the sensor element of the center button 502 to measure a capacitance on a sensor element of the center button 502.

FIG. 8D illustrates a cross-sectional view of one embodiment of a one-layer sensing device 875. The one-layer sensing device 875 includes a substrate 806, insulating material 809, the circular slider 504, center button 502, processing device 210, and grounded conductor 501. The sensor elements (e.g., 504(1)-(12)) of the circular slider 504 are disposed on the substrate 806 in a first plane of the first layer of the one-layer sensing device 875. The insulating material 809 is disposed on top of portions of the sensing areas of the sensor elements of the circular slider 504. The grounded conductor 501 and center button 502 are disposed on the insulating material 809 in a second plane of the first layer of the one-layer sensing device 875. The grounded conductor 501 and center button 502 are electrically isolated from one another, as well as from the sensor elements disposed on the first plane. Additional insulating material 809 may be disposed between the grounded conductor 501 and the center button 502. Alternatively, there may be an air gap between the grounded conductor 501 and the center button 502. The processing device 210 is also disposed on the substrate 806 in the first layer of the one-layer sensing device 875. The grounded conductor 501 is disposed in the second plane to shield portions of the sensing area of the sensor elements that are disposed on the first plane. The remaining portions of the sensing areas of the sensor elements are configured to operate as a circular slider 504 having an effective opening in the sensor elements within which the center button 502 is disposed. Alternatively, the processing device 210 is disposed on the opposite side of the substrate 806 in a second layer of a two-layer sensing device.

In another embodiment, the one-layer sensing device 875 does not include the grounded conductor 501 and the processing device 210 is configured to connect the sensor elements of the circular slider 504 to a system ground of the processing device 210, while sensing the sensor element of the center button 502 to measure a capacitance on a sensor element of the center button 502.

In one embodiment, the grounded conductor 501 and a sensor element of the center button 502 are conductive ink. Carbon ink is frequently used as a conductive ink for PCB manufacturing, but alternate types of conductive inks or pastes, such as silver ink, may be used. In another embodiment, the grounded conductor 501 and the sensor element of the center button 502 are metal, such as copper, gold, aluminum, or the like. Similarly, the sensor elements of the circular slider 504 may be conductive ink, metal, or other conductive material. In one embodiment, the sensor elements of the circular slider 504 are metal and the grounded conductor 501 and the sensor element of the center button 502 are conductive ink. Alternatively, the sensor elements of the circular slider 504, the center button 502, and the grounded conductor 501 may be similar or dissimilar conductive materials.

Alternatively, the embodiments described herein may be used in other configurations of single-layer or multi-layer sensing devices.

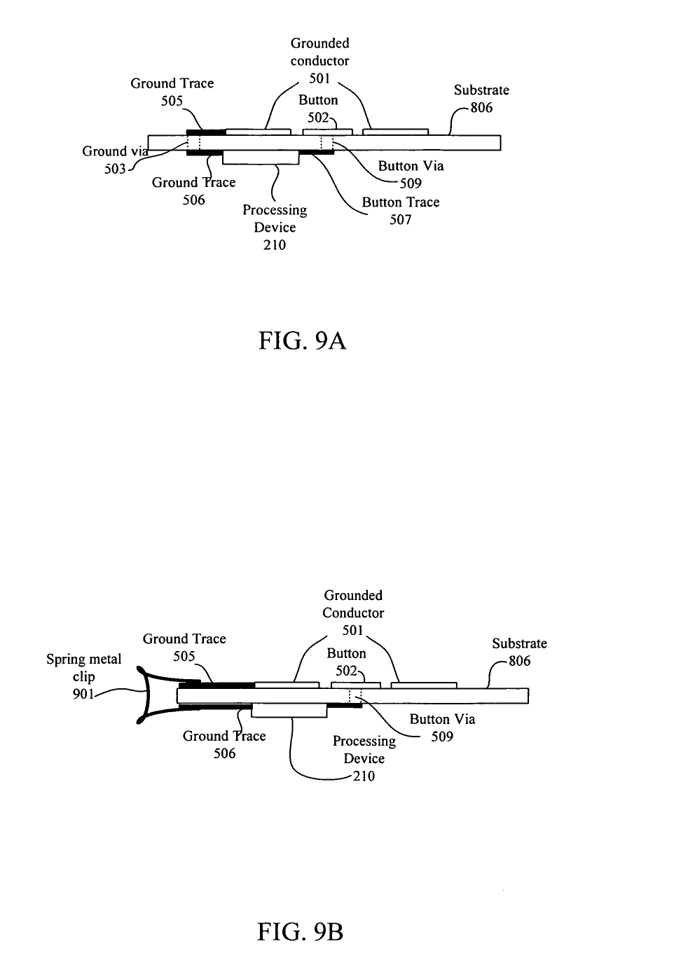

FIG. 9A illustrates a cross-sectional view of one embodiment of the circuit board 500 of FIGS. 5A and 5B having a grounded conductor 501 coupled to the processing device 210 using the button via 503. As described previously with respect to circuit board 500, the grounded conductor 501 is coupled to system ground of processing device 210 using the ground trace 505, the ground via 503, and the ground trace 506. The ground via 503 allows the ground trace 505 and ground trace 506 to be coupled through the substrate 806. Similarly, the center button 502 is coupled to the processing device 210 using button trace 507 and button via 509. Alternatively, the center button 502 and grounded conductor 501 are coupled to the processing device 210 using other configurations known by those of ordinary skill in the art.

In one embodiment, the ground conductor 501 is a ground plane. The ground plane may be formed as a sheet or a grid. The ground conductor 501 may be a carbon printed ground plane, or alternatively, other conductive materials. In another embodiment, the grounded conductor 501 is a sheet of conductive material and may be attached to the circuit board 500 using either adhesive or a mechanical mechanism for fastening the sheet of conductive material to the circuit board. Alternatively, the grounded conductor 501 may be implemented using conductive ink.

FIG. 9B illustrates a cross-sectional view of another embodiment of a circuit board 500 having a grounded conductor coupled to the processing device 210 using a spring metal clip. In this embodiment, the grounded conductor 501 is connected to system ground of the processing device 210 using ground trace 505, ground trace 506, and a pressure contact, spring metal clip 901. The spring metal clip 901 makes contact between the ground trace 505 and the ground trace 506. Alternatively, the pressure contact may be a ground wire screwed to the board, or other types of pressure contacts known by those of ordinary skill in the art, such as anisotropic conductive adhesive.

Alternatively, the grounded conductor 501 and center button 502 may be coupled to the processing device 210 using other connecting mechanisms than vias and pressure contacts, as known by those of ordinary skill in the art.

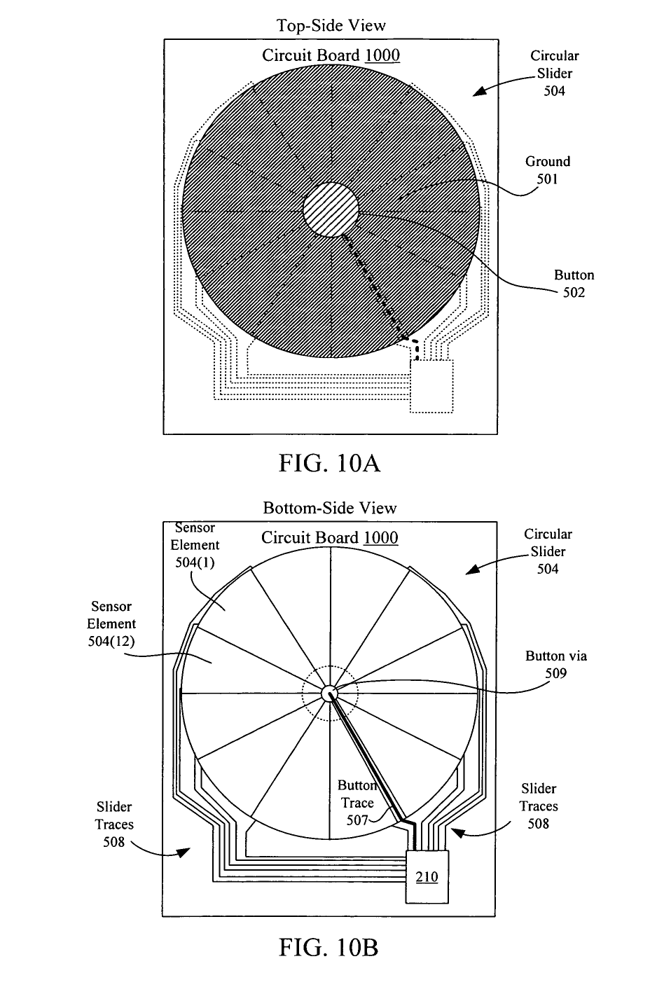

FIG. 10 illustrates top- and bottom-side views of one embodiment of a sensing device having a circular slider 504 disposed on a bottom layer and a center button 502 disposed on a top layer of a circuit board 500 and without a grounded conductor surrounding the center button 502 on the top layer. The top-side view of FIG. 10 illustrates a top layer of a circuit board 1000 of the sensing device. The center button 502 is disposed on the top layer of the circuit board 1000 in the top layer. The center button 502 may be a touch-sensor button or a mechanical button. Unlike the circuit board 500 of FIGS. 5A and 5B, the circuit board 1000 of FIG. 10 does not include the grounded conductor 501 that surrounds the center button 502 on the top layer.

On the bottom-side of the circuit board 1000 of the sensing device, the circular slider 504, including the non-linearly disposed sensor element 504(1)-(12), and the processing device 210 are disposed on the bottom layer of the circuit board 1000 (e.g., opposite side of the circuit board 1000). It should be noted that the top-side view of FIG. 10 illustrates the sensor elements 504(1)-(12) of the circular slider 504, the slider traces 508, the processing device 210, however, they have been illustrated as hashed lines and dotted lines to indicate that they are disposed on the bottom side of the circuit board 1000. The sensor elements 504(1)-(12) are pie-shaped, having a circular outer perimeter and two sides that converge substantially to a point in the center of the circular slider 504. Alternatively, the sensor elements may have other shapes and may be disposed in other non-linear configurations. Each of the sensor elements 504(1)-(12) are coupled to the processing device 210 using interconnecting traces, slider traces 580. The center button 502 is coupled to the processing device 210 using an interconnecting trace, button trace 507. The button trace 507 is electrically isolated from the sensor elements 504(7) and 504(8), and may be disposed in other configurations on the same layer (e.g., separate planes of the same layer) or on a different layer of the circuit board 1000. The button trace 507 may be coupled to the center button 502 through a via, button via 509, from the top side to the bottom side of the circuit board 1000.

The sensing device, as illustrated in FIG. 10, includes an outer sensing area and an inner sensing area. The twelve non-linearly disposed sensor elements 504(1)-(12) are disposed in the outer sensing area in a circle. Since the sensor elements are pie shaped, extending from the outer sensing area to the inner sensing area, portions of the sensing areas of the sensor elements 504(1)-(12) are located within the inner sensing area of the sensing device. The center button 502 is also disposed in the inner sensing area of the sensing device, but in a different plane or layer than the sensing elements 504(1)-(12). In one embodiment, the center button 502 is a touch-sensor button and includes a sensor element. This sensor element is a different sensor element than the sensor elements 504(1)-(12). Because the touch-sensor button is disposed on the top side of the circuit board 1000 and the sensor elements 504(1)-(12) are disposed on the bottom side of the circuit board 1000, the sensor elements of the circular slider 504 and the center button 502 are electrically isolated.

In this embodiment, since there is no grounded conductor to shield the portions of the sensing area of the sensor element 504(1)-(12) that are located within the inner sensing area, the processing device 210 is configured to connect some or all of the sensor elements 504(1)-(12) to a system ground of the processing device 210, while sensing the sensor element of the center button 502. For example, the center button 502 includes a sensor element and the processing device 210 is configured to connect the sensor elements 504(1)-(12) to a system ground of the processing device 210, while the sensor element is sensed to measure a capacitance on the sensor element of the center button 502.

In one embodiment, the processing device 210 is configured to detect the presence of a conductive object, manipulated by a user, on the sensing device. The processing device 210 may be configured to determine a button operation when the presence of the conductive object is detected on the inner sensing area of the sensing device that corresponds to the center button 502, and a slider operation when the presence of the conductive object is detected on the outer sensing area of the sensing device that corresponds to the sensor elements 504(1)-(12). The processing device 210 may also be configured to determine an absolute or relative position of the conductive object on the inner or outer sensing area of the sensing device.

As described above, the processing device 210 may be configured to sequentially sense the capacitance on each of the sensor element 504(1)-(12) and the sensor element of the center button 502, connecting the sensor elements 504(1)-(12) to system ground while the sensor element of the center button 502 is sensed.

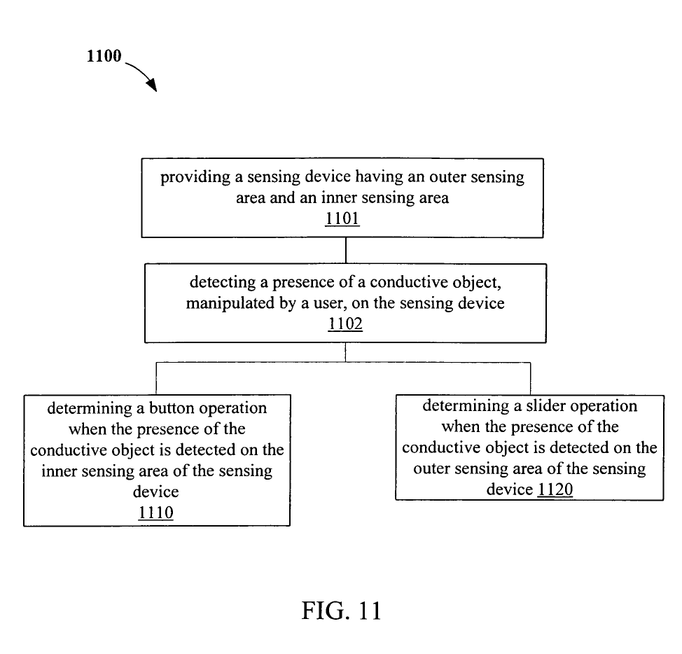

FIG. 11 illustrates a flow chart of one embodiment of a method 1100 for detecting a presence of a conductive object on the sensing device. The method 1100 includes providing a sensing device having an outer sensing area and an inner sensing area, operation 1101. The sensing device includes a plurality of non-linearly disposed sensor elements disposed in the outer sensing area and an additional sensor element disposed in the inner sensing area. Portions of the sensing areas of the plurality of non-linearly disposed sensor elements are located within the inner sensing area of the sensing device. The method further includes detecting a presence of a conductive object, manipulated by a user, on the sensing device, operation 1102.

The method 1100 may further include determining a button operation when the presence of the conductive object is detected on the inner sensing area of the sensing device, operation 1110, and determining a slider operation when the presence of the conductive object is detected on the outer sensing area of the sensing device, operation 1120.

In one embodiment, the sensing device includes a circular slider having a center button. In another embodiment, the sensing device includes a grounded conductor disposed to surround the additional sensor element that corresponds to the center button. The method may further include measuring a capacitance on the additional sensor element that is disposed in the inner sensing area. The method may include sequentially sensing each of the sensor elements of the circular slider and the additional sensor element of the center button to measure the capacitance on each of the sensor elements of the circular slider and the additional sensor element of the center button. Alternatively, the method may include substantially simultaneously sensing each of the sensor elements of the circular slider and the additional sensor element to measure the capacitance on each of the sensor element and the additional sensor element.

In another embodiment, the operation of detecting the presence of the conductive object includes measuring a capacitance on the additional sensor element disposed in the inner sensing area while grounding each of the sensor elements of the circular slider. The operation may further include measuring a capacitance on each of the sensor elements of the circular slider. Measuring the capacitance on the sensor elements of the circular slider may be done sequentially or substantially simultaneously.

Embodiments of the present invention, described herein, include various operations. These operations may be performed by hardware components, software, firmware, or a combination thereof. As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; electrical, optical, acoustical, or other form of propagated signal (e.g., carrier waves, infrared signals, digital signals, etc.); or another type of medium suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method, comprising:
providing a sensing device having an outer sensing area and an inner sensing area, wherein the sensing device comprises a plurality of non-linearly disposed sensor elements disposed in the outer sensing area and an additional sensor element disposed in the inner sensing area, and wherein portions of the sensing areas of the plurality of non-linearly disposed sensor elements are located within the inner sensing area; and
detecting a presence of a conductive object, manipulated by a user, on the sensing device.

2. The method of claim 1, further comprising determining a button operation when the presence of the conductive object is detected on the inner sensing area of the sensing device.

3. The method of claim 1, further comprising determining a slider operation when the presence of the conductive object is detected on the outer sensing area of the sensing device.

4. The method of claim 1, wherein the sensing device includes a circular slider having a center button, and wherein the additional sensor element corresponds to the center button in the inner sensing area of the sensing device, and the plurality of sensor elements correspond to the circular slider in the outer sensing area of the sensing device.

5. The method of claim 1, wherein the sensing device further comprises a grounded conductor disposed to surround the additional sensor element of a center button, and wherein detecting the presence of the conductive object on the inner sensing area comprises measuring a capacitance on the additional sensor element disposed in the inner sensing area.

6. The method of claim 5, further comprising sequentially sensing each of the plurality of non-linearly disposed sensor elements and the additional sensor element to measure the capacitance on each of the plurality of non-linearly disposed sensor elements and the additional sensor element.

7. The method of claim 5, further comprising substantially simultaneously sensing each of the plurality of non-linearly disposed sensor elements and the additional sensor element to measure the capacitance on each of the plurality of non-linearly disposed sensor elements and the additional sensor element.

8. The method of claim 1, wherein detecting the presence of the conductive object on the inner sensing area comprises measuring a capacitance on the additional sensor element disposed in the inner sensing area while grounding each of the plurality of non-linearly disposed sensor elements of the outer sensing area.

9. The method of claim 8, further comprising sequentially sensing each of the plurality of non-linearly disposed sensor elements and the additional sensor element to measure the capacitance on each of the plurality of non-linearly disposed sensor elements and the additional sensor element.

10. An apparatus, comprising
a sensing device having an outer sensing area and an inner sensing area, wherein the sensing device comprises a plurality of non-linearly disposed sensor elements disposed in the outer sensing area and an additional sensor element disposed in the inner sensing area,
wherein portions of the sensing areas of the plurality of non-linearly disposed sensor elements are located within the inner sensing area, and
wherein the inner sensing area is located within the outer sensing area of the plurality of sensor elements.

11. The apparatus of claim 10, wherein the plurality of non-linearly disposed sensor elements are disposed in a first layer of a circuit board, wherein portions of the sensing areas of the plurality of non-linearly disposed sensor elements are located within the inner sensing area, and wherein the additional sensor element is disposed in a second layer of the circuit board.

12. The apparatus of claim 11, further comprising a grounded conductor disposed to surround the additional sensor element, wherein the grounded conductor is configured to shield the portions of the sensing areas of the plurality of non-linearly disposed sensor elements that are located within the inner sensing area.

13. The apparatus of claim 11, wherein the grounded conductor is disposed on the second layer of the circuit board.

14. The apparatus of claim 11, wherein the grounded conductor is disposed on a third layer of the circuit board.

15. The apparatus of claim 11, further comprising a processing device coupled to the plurality of sensor elements and the additional sensor element, wherein the processing device is configured to connect the plurality of sensor elements to a system ground while sensing the additional sensor element to measure a capacitance on the additional sensor element.

16. The apparatus of claim 10, wherein the sensing device includes a circular slider having a center button, and wherein the additional sensor element corresponds to the center button in the inner sensing area of the sensing device, and the plurality of sensor elements correspond to the circular slider in the outer sensing area of the sensing device.

17. The apparatus of claim 10, further comprising a processing device coupled to the plurality of sensor elements and the additional sensor element, wherein the processing device is configured to detect a presence of the conductive object, manipulated by a user, on the sensing device.

18. The apparatus of claim 17, wherein the processing device is configured to determine a button operation when the presence of the conductive object is detected on the inner sensing area of the sensing device, and a slider operation when the presence of the conductive object is detected on the outer sensing area of the sensing device.

19. The apparatus of claim 17, wherein the processing device is configured to determine a position of the presence of the conductive object on the outer sensing area of the sensing device.

20. The apparatus of claim 17, wherein the processing device is configured to either sequentially or substantially simultaneously sense each of the plurality of sensor elements and the additional sensor element to measure a capacitance on each of the plurality of sensor elements and the additional sensor element.

21. The apparatus of claim 17, wherein the processing device is configured to sequentially sense each of the plurality of sensor elements and the additional sensor element to measure a capacitance on each of the plurality of sensor elements and the additional sensor element, and to connect each of the plurality of sensor elements to a system ground while the additional sensor element is sensed.

22. An apparatus, comprising:
a sensing device having an outer sensing area and an inner sensing area, wherein the sensing device comprises a plurality of non-linearly disposed sensor elements disposed in the outer sensing area and an additional sensor element disposed in the inner sensing area, and wherein portions of the sensing areas of the plurality of non-linearly disposed sensor elements are located within the inner sensing area; and
means for detecting a presence of a conductive object, manipulated by a user on the sensing device.

23. The apparatus of claim 22, further comprising:
means for sensing the plurality of non-linearly disposed sensor elements and the additional sensor element of the sensing device; and
means for shielding the portions of sensing area of the plurality of sensor elements while sensing each of the plurality of non-linearly disposed sensor elements and the additional sensor element of the sensing device.

24. The apparatus of claim 22, further comprising:
means for sensing the plurality of non-linearly disposed sensor elements and the additional sensor element of the sensing device; and
means for grounding each of plurality of non-linearly disposed sensor elements while sensing the additional sensor element of the sensing device.
